(19) United States
(12) Patent Application Publication
(10) Pub. No.: US 2025/0008433 A1
(43) Pub. Date: Jan. 2, 2025

(54) METHOD FOR TRANSMITTING AND RECEIVING DATA ON BASIS OF SL DRX IN WIRELESS COMMUNICATION SYSTEM, AND APPARATUS THEREFOR

(71) Applicant: LG Electronics Inc., Seoul (KR)

(72) Inventors: Giwon PARK, Seoul (KR); Hanbyul SEO, Seoul (KR); Seoyoung BACK, Seoul (KR); Jongwoo HONG, Seoul (KR)

(21) Appl. No.: 18/689,780

(22) PCT Filed: Sep. 5, 2022
(86) PCT No.: PCT/KR2022/013289

§ 371 Date: Mar. 6, 2024

Related U.S. Application Data
(60) Provisional application No. 63/241,092, filed on Sep. 6, 2021.

(51) Int. Cl. H04W 52/02; H04W 72/0446; H04W 72/25

(52) U.S. Cl. CPC H04W 52/0229; H04W 72/0446; H04W 72/25

(57) ABSTRACT

A method according to an embodiment of the present disclosure includes receiving SCI from a first UE and receiving data from the first UE based on the SCI. The SCI is received through monitoring performed in an active time based on a configuration related to SL DRX. The active time includes a time duration in which a pre-configured SL DRX timer is running. The time duration in which the pre-configured SL DRX timer is running includes one or more slots based on a predefined value. A slot of a resource pool other than a predefined resource pool among slots determined by physical slot indexes related to the predefined value is excluded from the one or more slots.

### TECHNICAL FIELD

The present disclosure relates to a wireless communication system.

### BACKGROUND ART

A wireless communication system is a multiple access system that supports communication of multiple users by sharing available system resources (e.g. a bandwidth, transmission power, etc.) among them. Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi-Carrier Frequency Division Multiple Access (MC-FDMA) system.

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

### DISCLOSURE

### Detailed Description

In the present disclosure, “A or B” may mean “only A”, “only B” or “both A and B.” In other words, in the present disclosure, “A or B” may be interpreted as “A and/or B”. For example, in the present disclosure, “A. B, or C” may mean “only A”, “only B”, “only C”, or “any combination of A. B. C”.

A slash (/) or comma used in the present disclosure may mean “and/or”. For example, “A/B” may mean “A and/or B”. Accordingly, “A/B” may mean “only A”, “only B”, or “both A and B”. For example, “A. B. C” may mean “A. B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, in the present disclosure, “at least one of A. B, and C” may mean “only A”. “only B”, “only C”, or “any combination of A. B, and C”. In addition, “at least one of A. B, or C” or “at least one of A. B, and/or C” may mean “at least one of A. B, and C”.

In addition, a parenthesis used in the present disclosure may mean “for example”. Specifically, when indicated as “control information (PDCCH)”, it may mean that “PDCCH” is proposed as an example of the “control information”. In other words, the “control information” of the present disclosure is not limited to “PDCCH”, and “PDCCH” may be proposed as an example of the “control information”. In addition, when indicated as “control information (i.e., PDCCH)”, it may also mean that “PDCCH” is proposed as an example of the “control information”.

In the following description, “when, if, or in case of may be replaced with based on”.

A technical feature described individually in one figure in the present disclosure may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

For terms and techniques not specifically described among terms and techniques used in the present disclosure, reference may be made to a wireless communication standard document published before the present disclosure is filed. For example, the following document may be referred to.

| 3GPP LTE | 3GPP NR (e.g. 5G) |
|---|---|
| 3GPP TS 36.211: Physical channels and | 3GPP TS 38.211: Physical channels and |
| modulation | modulation |
| 3GPP TS 36.212: Multiplexing and channel | 3GPP TS 38.212: Multiplexing and channel |
| coding | coding |
| 3GPP TS 36.213: Physical layer procedures | 3GPP TS 38.213: Physical layer procedures |
| 3GPP TS 36.214: Physical layer; | for control |
| Measurements | 3GPP TS 38.214: Physical layer procedures |
| 3GPP TS 36.300: Overall description | for data |
| 3GPP TS 36.304: User Equipment (UE) | 3GPP TS 38.215: Physical layer |
| procedures in idle mode | measurements |
| 3GPP TS 36.314: Layer 2 - Measurements | 3GPP TS 38.300: Overall description |
| 3GPP TS 36.321: Medium Access Control | 3GPP TS 38.304: User Equipment (UE) |
| (MAC) protocol | procedures in idle mode and in RRC inactive |
| 3GPP TS 36.322: Radio Link Control (RLC) | state |
| protocol | 3GPP TS 38.321: Medium Access Control |
| 3GPP TS 36.323: Packet Data Convergence | (MAC) protocol |
| Protocol (PDCP) | 3GPP TS 38.322: Radio Link Control (RLC) |
| 3GPP TS 36.331: Radio Resource Control | protocol |
| (RRC) protocol | 3GPP TS 38.323: Packet Data Convergence |
| | Protocol (PDCP) |
| | 3GPP TS 38.331: Radio Resource Control |
| | (RRC) protocol |
| | 3GPP TS 37.324: Service Data Adaptation |
| | Protocol (SDAP) |
| | 3GPP TS 37.340: Multi-connectivity; Overall |
| | description |

FIG. Z1 shows a structure of an NR system, based on an embodiment of the present disclosure. The embodiment of FIG. Z1 may be combined with various embodiments of the present disclosure.

Referring to FIG. Z1, a next generation-radio access network (NG-RAN) may include a BS 20 providing a UE 10 with a user plane and control plane protocol termination. For example, the BS 20 may include a next generation-Node B (gNB) and/or an evolved-NodeB (eNB). For example, the UE 10 may be fixed or mobile and may be referred to as other terms, such as a mobile station (MS), a user terminal (UT), a subscriber station (SS), a mobile terminal (MT), wireless device, and so on. For example, the BS may be referred to as a fixed station which communicates with the UE 10 and may be referred to as other terms, such as a base transceiver system (BTS), an access point (AP), and so on.

The embodiment of FIG. Z1 exemplifies a case where only the gNB is included. The BSs 20 may be connected to one another via Xn interface. The BS 20 may be connected to one another via 5th generation (5G) core network (5GC) and NG interface. More specifically, the BSs 20 may be connected to an access and mobility management function (AMF) 30 via NG-C interface, and may be connected to a user plane function (UPF) 30 via NG-U interface.

FIG. Z2 shows a functional division between an NG-RAN and a 5GC, based on an embodiment of the present disclosure. The embodiment of FIG. Z2 may be combined with various embodiments of the present disclosure.

Referring to FIG. Z2, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring. Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

FIG. Z3 shows a radio protocol architecture, based on an embodiment of the present disclosure. The embodiment of FIG. Z3 may be combined with various embodiments of the present disclosure. Specifically. (a) of FIG. Z3 shows a radio protocol architecture, and (b) of FIG. Z3 shows a radio protocol architecture. A user plane is a protocol stack for user data transmission, and a control plane is a protocol stack for control signal transmission.

Referring to FIG. Z3, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QOS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., a MAC layer, an RLC layer, and a packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QOS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

A physical channel is configured of a plurality of OFDM symbols in the time domain and a plurality of sub-carriers in the frequency domain. One subframe is configured of a plurality of OFDM symbols in the time domain. A resource block is configured of a plurality of OFDM symbols and a plurality of sub-carriers in resource allocation units. Additionally, each subframe may use specific sub-carriers of specific OFDM symbols (e.g., first OFDM symbol) of the corresponding subframe for a Physical Downlink Control Channel (PDCCH), i.e., L1/L2 control channels. A Transmission Time Interval (TTI) refers to a unit time of a subframe transmission.

FIG. Z4 shows a structure of a radio frame of an NR, based on an embodiment of the present disclosure. The embodiment of FIG. Z4 may be combined with various embodiments of the present disclosure.

Referring to FIG. Z4, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined based on subcarrier spacing (SCS). Each slot may include 12 or 14 OFDM (A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table Z1 shown below represents an example of a number of symbols per slot (N^{slot}_{symb}), a number slots per frame (N^{frame,u}ₛₗₒₜ), and a number of slots per subframe (N^{subframe,u}ₛₗₒₜ) based on an SCS configuration (u), in a case where a normal CP is used.

TABLE Z1

| SCS (15*2^{u}) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

Table Z2 shows an example of a number of symbols per slot, a number of slots per frame, and a number of slots per subframe based on the SCS, in a case where an extended CP is used.

TABLE Z2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In an NR system, OFDM (A) numerologies (e.g., SCS. CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 KHz/60 kHz a dense-urban, lower latency, wider carrier bandwidth may be supported. In case the SCS is 60 KHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table Z3. Among the frequency ranges that are used in an NR system. FR1 may mean a “sub 6 GHz range”, and FR2 may mean an “above 6 GHz range” and may also be referred to as a millimeter wave (mmW).

TABLE Z3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed (or varied). For example, as shown below in Table Z4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE Z4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

FIG. Z5 shows a structure of a slot of an NR frame, based on an embodiment of the present disclosure. The embodiment of FIG. Z5 may be combined with various embodiments of the present disclosure.

Referring to FIG. Z5, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRBs) for the given numerology on a given carrier

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a location change of the bandwidth, or a change in subcarrier spacing of the bandwidth.

For example, the bandwidth may be decreased during a period in which activity is low to save power. For example, the location of the bandwidth may move in a frequency domain. For example, the location of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be referred to as a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, physical downlink shared channel (PDSCH), or channel state information-reference signal (CSI-RS) (excluding RRM) outside the active DL BWP. For example, the UE may not trigger a channel state information (CSI) report for the inactive DL BWP. For example, the UE may not transmit physical uplink control channel (PUCCH) or physical uplink shared channel (PUSCH) outside an active UL BWP. For example, in a downlink case, the initial BWP may be given as a consecutive RB set for a remaining minimum system information (RMSI) control resource set (CORESET) (configured by physical broadcast channel (PBCH)). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit a SL channel or a SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-) configured in a carrier with respect to an out-of-coverage NR V2X UE and an RRC_IDLE UE. For the UE in the RRC_CONNECTED mode, at least one SL BWP may be activated in the carrier.

FIG. Z6 shows an example of a BWP, based on an embodiment of the present disclosure. The embodiment of FIG. Z6 may be combined with various embodiments of the present disclosure. It is assumed in the embodiment of FIG. Z6 that the number of BWPs is 3.

Referring to FIG. Z6, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described.

FIG. Z7 shows a radio protocol architecture for SL communication, based on an embodiment of the present disclosure. The embodiment of FIG. Z7 may be combined with various embodiments of the present disclosure. Specifically. (a) of FIG. Z7 shows a user plane protocol stack, and (b) of FIG. Z7 shows a control plane protocol stack.

Hereinafter, a sidelink synchronization signal (SLSS) and synchronization information will be described.

A sidelink synchronization signal (SLSS) may include a primary sidelink synchronization signal (PSSS) and a secondary sidelink synchronization signal (SSSS), as a SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit cyclic redundancy check (CRC).

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-) configured sidelink (SL) BWP. For example, the S-SSB may have a bandwidth of 11 resource blocks (RBs). For example, the PSBCH may exist across 11 RBs. In addition, a frequency position of the S-SSB may be (pre-) configured. Accordingly, the UE does not have to perform hypothesis detection at frequency to discover the S-SSB in the carrier.

For example, based on Table Z5, the UE may generate an S-SS/PSBCH block (i.e., S-SSB), and the UE may transmit the S-SS/PSBCH block (i.e., S-SSB) by mapping it on a physical resource.

TABLE Z5
8.4.3.1 Time-frequency structure of an S-SS/PSBCH block
In the time domain, an S-SS/PSBCH block consists of N_{symb}^{S-SSB} OFDM symbols, numbered in increasing order from 0
to N_{symb}^{S-SSB} − 1 within the S-SS/PSBCH block, where S-PSS, S-SSS, and PSBCH with associated DM-RS are mapped
to symbols as given by Table 8.4.3.1-1. The number of OFDM symbols in an S-SS/PSBCH block N_{symb}^{S-SSB} = 13 for
normal cyclic prefix and N_{symb}^{S-SSB} = 11 for extended cyclic prefix. The first OFDM symbol in an S-SS/PSBCH block is
the first OFDM symbol in the slot.
In the frequency domain, an S-SS/PSBCH block consists of 132 contiguous subcarriers with the subcarriers numbered
in increasing order from 0 to 131 within the sidelink S-SS/PSBCH block. The quantities k and l represent the
frequency and time indices, respectively, within one sidelink S-SS/PSBCH block.
For an S-SS/PSBCH block, the UE shall use

| | |
|---|---|
| - | antenna port 4000 for transmission of S-PSS, S-SSS, PSBCH and DM-RS for PSBCH; |
| - | the same cyclic prefix length and subcarrier spacing for the S-PSS, S-SSS, PSBCH and DM-RS for PSBCH, |

Table 8.4.3.1-1: Resources within an S-SS/PSBCH block for S-PSS, S-SSS, PSBCH, and DM-RS.

| | OFDM symbol number l | Subcarrier number k |
|---|---|---|
| Channel | relative to the start | relative to the start |
| or signal | of an S-SS/PSBCH block | of an S-SS/PSBCH block |
| S-PSS | 1, 2 | 2, 3, . . . , 127, 128 |
| S-SSS | 3, 4 | 2, 3, . . . , 127, 128 |
| Set to zero | 1, 2, 3, 4 | 0, 1, 129, 130, 131 |
| PSBCH | 0, 5, 6, . . . , N_{symb}^{S-SSB} − 1 | 0, 1, . . . , 131 |
| DM-RS for | 0, 5, 6, . . . , N_{symb}^{S-SSB} − 1 | 0, 4, 8, . . . , 128 |
| PSBCH | | |

Hereinafter, synchronization acquisition of a SL UE will be described.

In time division multiple access (TDMA) and frequency division multiple access (FDMA) systems, accurate time and frequency synchronization is essential. If the time and frequency synchronization is not accurate, system performance may be degraded due to inter symbol interference (ISI) and inter carrier interference (ICI). The same is true for V2X. In V2X, for time/frequency synchronization, sidelink synchronization signal (SLSS) may be used in a physical layer, and master information block-sidelink-V2X (MIB-SL-V2X) may be used in a radio link control (RLC) layer.

FIG. Z8 shows a synchronization source or synchronization reference of V2X based on an embodiment of the present disclosure. The embodiment of FIG. Z8 may be combined with various embodiments of the present disclosure.

Referring to FIG. Z8, in V2X, a UE may be directly synchronized with a global navigation satellite system (GNSS), or may be indirectly synchronized with the GNSS through a UE (inside network coverage or outside network coverage) directly synchronized with the GNSS. If the GNSS is configured as the synchronization source, the UE may calculate a DFN and a subframe number by using a coordinated universal time (UTC) and a (pre-) configured direct frame number (DFN) offset.

Alternatively, the UE may be directly synchronized with a BS, or may be synchronized with another UE which is time/frequency-synchronized with the BS. For example, the BS may be an eNB or a gNB. For example, if the UE is inside the network coverage, the UE may receive synchronization information provided by the BS, and may be directly synchronized with the BS. Thereafter, the UE may provide the synchronization information to adjacent another UE. If BS timing is configured based on synchronization, for synchronization and downlink measurement, the UE may be dependent on a cell related to a corresponding frequency (when it is inside the cell coverage at the frequency), or a primary cell or a serving cell (when it is outside the cell coverage at the frequency).

The BS (e.g., serving cell) may provide a synchronization configuration for a carrier used in V2X or SL communication. In this case, the UE may conform to the synchronization configuration received from the BS. If the UE fails to detect any cell in a carrier used in the V2X or SL communication and fails to receive the synchronization configuration from the serving cell, the UE may conform to a pre-configured synchronization configuration.

Alternatively, the UE may be synchronized with another UE which fails to obtain synchronization information directly or indirectly from the BS or the GNSS. A synchronization source or preference may be pre-configured to the UE. Alternatively, the synchronization source and preference may be configured through a control message provided by the BS.

An SL synchronization source may be associated/related with a synchronization priority. For example, a relation between the synchronization source and the synchronization priority may be defined as shown in Table Z6 or Table Z7, Table Z6 or Table Z7 are for exemplary purposes only, and the relation between the synchronization source and the synchronization priority may be defined in various forms.

TABLE Z6

| Priority | GNSS-based | eNB/gNB-based |
|---|---|---|
| level | synchronization | synchronization |
| P0 | GNSS | BS |
| P1 | All UEs directly synchronized with | All UEs directly synchronized with BS |
| | GNSS | |
| P2 | All UEs indirectly synchronized with | All UEs indirectly synchronized with |
| | GNSS | BS |
| P3 | All other UEs | GNSS |
| P4 | N/A | All UEs directly synchronized with |
| | | GNSS |
| P5 | N/A | All UEs indirectly synchronized with |
| | | GNSS |
| P6 | N/A | All other UEs |

TABLE Z7

| Priority | GNSS-based | eNB/gNB-based |
|---|---|---|
| level | synchronization | synchronization |
| P0 | GNSS | BS |
| P1 | All UEs directly synchronized with | All UEs directly synchronized with BS |
| | GNSS | |
| P2 | All UEs indirectly synchronized with | All UEs indirectly synchronized with |
| | GNSS | BS |
| P3 | BS | GNSS |
| P4 | All UEs directly synchronized with BS | All UEs directly synchronized with |
| | | GNSS |
| P5 | All UEs indirectly synchronized with | All UEs indirectly synchronized with |
| | BS | GNSS |
| P6 | Remaining UE(s) having low priority | Remaining UE(s) having low priority |

In Table Z6 or Table Z7, P0 may denote a highest priority, and P6 may denote a lowest priority. In Table Z6 or Table Z7, the BS may include at least one of a gNB and an eNB.

Whether to use GNSS-based synchronization or BS-based synchronization may be (pre-) configured. In a single-carrier operation, the UE may derive transmission timing of the UE from an available synchronization reference having the highest priority.

For example, the UE may (re) select a synchronization reference, and the UE may obtain synchronization from the synchronization reference. In addition, the UE may perform SL communication (e.g., PSCCH/PSSCH transmission/reception, physical sidelink feedback channel (PSFCH) transmission/reception, S-SSB transmission/reception, reference signal transmission/reception, etc.) based on the obtained synchronization.

FIG. Z9 shows a procedure of performing V2X or SL communication by a UE based on a transmission mode, based on an embodiment of the present disclosure. The embodiment of FIG. Z9 may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, (a) of FIG. Z9 shows a UE operation related to an LTE transmission mode 1 or an LTE transmission mode 3. Alternatively, for example, (a) of FIG. Z9 shows a UE operation related to an NR resource allocation mode 1. For example, the LTE transmission mode 1 may be applied to general SL communication, and the LTE transmission mode 3 may be applied to V2X communication.

For example, (b) of FIG. Z9 shows a UE operation related to an LTE transmission mode 2 or an LTE transmission mode 4. Alternatively, for example, (b) of FIG. Z9 shows a UE operation related to an NR resource allocation mode 2.

Referring to (a) of FIG. Z9, in the LTE transmission mode 1, the LTE transmission mode 3, or the NR resource allocation mode 1, a base station may schedule SL resource(s) to be used by a UE for SL transmission. For example, in step S8000, a base station may transmit information related to SL resource(s) and/or information related to UL resource(s) to a first UE. For example, the UL resource(s) may include PUCCH resource(s) and/or PUSCH resource(s). For example, the UL resource(s) may be resource(s) for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

In step S8010, the first UE may transmit a PSCCH (e.g., sidelink control information (SCI) or 1^{st}-stage SCI) to a second UE based on the resource scheduling. In step S8020, the first UE may transmit a PSSCH (e.g., 2^{nd}-stage SCI. MAC PDU, data, etc.) related to the PSCCH to the second UE. In step S8030, the first UE may receive a PSFCH related to the PSCCH/PSSCH from the second UE. For example, HARQ feedback information (e.g., NACK information or ACK information) may be received from the second UE through the PSFCH. In step S8040, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling. For example, a format of the DCI may be a DCI format 3_0 or a DCI format 3_1. Table Z8 shows an example of a DCI for SL scheduling.

TABLE Z8
3GPP TS 38.212

7.3.1.4.1 Format 3_0
DCI format 3_0 is used for scheduling of NR PSCCH and NR PSSCH in one cell.
The following information is transmitted by means of the DCI format 3_0 with CRC scrambled by SL-RNTI or SL-
CS-RNTI:

| - | Resource pool index -┌log₂ I┐ bits, where I is the number of resource pools for transmission configured by the | |
|---|---|---|
| | higher layer parameter sl-TxPoolScheduling. | |
| - | Time gap - 3 bits determined by higher layer parameter sl-DCI-ToSL-Trans, as defined in clause 8.1.2.1 of [6, | |
| | TS 38.214] | |
| - | HARQ process number - 4 bits as defined in clause 16.4 of [5, TS 38.213] | |
| - | New data indicator - 1 bit as defined in clause 16.4 of [5, TS 38.213] | |
| - | Lowest index of the subchannel allocation to the initial transmission -┌log₂(N_{subChannel}^{SL})┐ bits as defined in | |
| | clause 8.1.2.2 of [6, TS 38.214] | |
| - | SCI format 1-A fields according to clause 8.3.1.1: | |
| | - | Frequency resource assignment. |
| | - | Time resource assignment. |
| - | PSFCH-to-HARQ feedback timing indicator -┌log₂ N_{fb}_{_{—}}_{timing}┐ bits, where N_{fb}_{_{—}}_{timing} is the number of entries | |
| | in the higher layer parameter sl-PSFCH-ToPUCCH, as defined in clause 16.5 of [5, TS 38.213] | |
| - | PUCCH resource indicator - 3 bits as defined in clause 16.5 of [5, TS 38.213]. | |
| - | Configuration index - 0 bit if the UE is not configured to monitor DCI format 3_0 with CRC scrambled by SL- | |
| | CS-RNTI; otherwise 3 bits as defined in clause 8.1.2 of [6, TS 38.214]. If the UE is configured to monitor DCI | |
| | format 3_0 with CRC scrambled by SL-CS-RNTI, this field is reserved for DCI format 3_0 with CRC | |
| | scrambled by SL-RNTI. | |
| - | Counter sidelink assignment index - 2 bits | |
| | - | 2 bits as defined in clause 16.5.2 of [5, TS 38.213] if the UE is configured with pdsch-HARQ-ACK- |
| | | Codebook = dynamic |
| | - | 2 bits as defined in clause 16.5.1 of [5, TS 38.213] if the UE is configured with pdsch-HARQ-ACK- |

Codebook = semi-static

| | |
|---|---|
| - | Padding bits, if required |

7.3.1.4.2 Format 3_1
DCI format 3_1 is used for scheduling of LTE PSCCH and LTE PSSCH in one cell.
The following information is transmitted by means of the DCI format 3_1 with CRC scrambled by SL-L-CS-RNTI:

| | |
|---|---|
| - | Timing offset - 3 bits determined by higher layer parameter sl-TimeOffsetEUTRA, as defined in clause 16.6 of |
| | [5, TS 38.213] |
| - | Carrier indicator -3 bits as defined in 5.3.3.1.9A of [11, TS 36.212]. |
| - | Lowest index of the subchannel allocation to the initial transmission - ┌log₂(N_{subchannel}^{SL})┐ bits as defined in |
| | 5.3.3.1.9A of [11, TS 36.212]. |
| - | Frequency resource location of initial transmission and retransmission, as defined in 5.3.3.1.9A of [11, TS |
| | 36.212] |
| - | Time gap between initial transmission and retransmission, as defined in 5.3.3.1.9A of [11, TS 36.212] |
| - | SL index - 2 bits as defined in 5.3.3.1.9A of [11, TS 36.212] |
| - | SL SPS configuration index - 3 bits as defined in clause 5.3.3.1.9A of [11, TS 36.212]. |
| - | Activation/release indication - 1 bit as defined in clause 5.3.3.1.9A of [11, TS 36.212]. |

Referring to (b) of FIG. Z9, in the LTE transmission mode 2, the LTE transmission mode 4, or the NR resource allocation mode 2, a UE may determine SL transmission resource(s) within SL resource(s) configured by a base station/network or pre-configured SL resource(s). For example, the configured SL resource(s) or the pre-configured SL resource(s) may be a resource pool. For example, the UE may autonomously select or schedule resource(s) for SL transmission. For example, the UE may perform SL communication by autonomously selecting resource(s) within the configured resource pool. For example, the UE may autonomously select resource(s) within a selection window by performing a sensing procedure and a resource (re) selection procedure. For example, the sensing may be performed in a unit of subchannel(s). For example, in step S8010, a first UE which has selected resource(s) from a resource pool by itself may transmit a PSCCH (e.g., sidelink control information (SCI) or 1^{st}-stage SCI) to a second UE by using the resource(s). In step S8020, the first UE may transmit a PSSCH (e.g., 2^{nd}-stage SCI, MAC PDU, data, etc.) related to the PSCCH to the second UE. In step S8030, the first UE may receive a PSFCH related to the PSCCH/PSSCH from the second UE.

Referring to (a) or (b) of FIG. Z9, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1^{st} SCI, a first SCI, a 1^{st}-stage SCI or a 1^{st}-stage SCI format, and a SCI transmitted through a PSSCH may be referred to as a 2^{nd} SCI, a second SCI, a 2^{nd}-stage SCI or a 2^{nd}-stage SCI format. For example, the 1^{st}-stage SCI format may include a SCI format 1-A, and the 2^{nd}-stage SCI format may include a SCI format 2-A and/or a SCI format 2-B. Table Z9 shows an example of a 1^{st}-stage SCI format.

TABLE Z9
3GPP TS 38.212
8.3.1.1 SCI format 1-A
SCI format 1-A is used for the scheduling of PSSCH and 2^{nd}-stage-SCI on PSSCH
The following information is transmitted by means of the SCI format 1-A:

| | |
|---|---|
| - | Priority - 3 bits as specified in clause 5.4.3.3 of [12, TS 23.287] and clause 5.22.1.3.1 of [8, TS 38.321]. |
| - | $Frequency resource assignment - ⌈ {log}_{2} ( \frac{{N}_{subChan nel}^{SL} ( {N}_{subChannel}^{SL} + 1 )}{2} ) ⌉ bits when the value of the higher layer$ |
| | $paramenter sl - MaxNumPerReserve is configured to 2 ; otherwise ⌈ {log}_{2} ( \frac{{N}_{subChan nel}^{SL} ( {N}_{subChan nel}^{SL} + 1 ) ( 2 {N}_{subChan nel}^{SL} + 1 )}{6} ) ⌉$ |
| | bits when the value of the higher layer parameter sl-MaxNumPerReserve is configured to 3, as defined in clause |
| | 8.1.2.2 of [6, TS 38.214]. |
| - | Time resource assignment - 5 bits when the value of the higher layer parameter sl-MaxNumPerReserve is |
| | configured to 2; otherwise 9 bits when the value of the higher layer parameter sl-MaxNumPerReserve is |
| | configured to 3, as defined in clause 8.1.2.1 of [6, TS 38.214]. |
| - | Resource reservation period -┌log₂ Nᵣₛᵥ_period┐ bits as defined in clause 8.1.4 of [6, TS 38.214], where |
| | Nᵣₛᵥ_period is the number of entries in the higher layer parameter sl-ResourceReservePeriodList, if higher layer |
| | parameter sl-MultiReserveResource is configured; 0 bit otherwise. |
| - | DMRS pattern - ┌log₂ Nₚₐₜₜₑᵣₙ┐ bits as defined in clause 8.4.1.1.2 of [4, TS 38.211], where Nₚₐₜₜₑᵣₙ is the |
| | number of DMRS patterns configured by higher layer parameter sl-PSSCH-DMRS-TimePatternList. |
| - | 2^{nd}-stage SCI format - 2 bits as defined in Table 8.3.1.1-1. |
| - | Beta_offset indicator - 2 bits as provided by higher layer parameter sl-BetaOffsets2ndSCI and Table 8.3.1.1-2. |
| - | Number of DMRS port - 1 bit as defined in Table 8.3.1.1-3. |
| - | Modulation and coding scheme - 5 bits as defined in clause 8.1.3 of [6, TS 38.214]. |
| - | Additional MCS table indicator - as defined in clause 8.1.3.1 of [6, TS 38.214]: 1 bit if one MCS table is |
| | configured by higher layer parameter sl-Additional-MCS-Table; 2 bits if two MCS tables are configured by |
| | higher layer parameter sl- Additional-MCS-Table; 0 bit otherwise. |
| - | PSFCH overhead indication - 1 bit as defined clause 8.1.3.2 of [6, TS 38.214] if higher layer parameter sl- |
| | PSFCH-Period = 2 or 4; 0 bit otherwise. |
| - | Reserved - a number of bits as determined by higher layer parameter sl-NumReservedBits, with value set to |
| | zero. |

Table 8.3.1.1-1: 2^{nd}-stage SCI formats

| Value of 2nd-stage SCI | |
|---|---|
| format field | 2nd-stage SCI format |
| 00 | SCI format 2-A |
| 01 | SCI format 2-B |
| 10 | Reserved |
| 11 | Reserved |

Table 8.3.1.1-2: Mapping of Beta_offset indicator values to indexes in Table 9.3-2 of [5, TS38.213]

| Value of Beta_offset | Beta_offset index in Table 9.3-2 of |
|---|---|
| indicator | [5, TS38.213] |
| 00 | 1st index provided by higher layer parameter sl- |
| | BetaOffsets2ndSCI |
| 01 | 2nd index provided by higher layer parameter sl- |
| | BetaOffsets2ndSCI |
| 10 | 3rd index provided by higher layer parameter sl- |
| | BetaOffsets2ndSCI |
| 11 | 4th index provided by higher layer parameter sl- |
| | BetaOffsets2ndSCI |

Table 8.3.1.1-3: Number of DMRS port(s)

| Value of the Number of | |
|---|---|
| DMRS port field | Antenna ports |
| 0 | 1000 |
| 1 | 1000 and 1001 |

Table Z10 shows an example of a 2^{nd}-stage SCI format.

TABLE Z10
3GPP TS 38.212

8.4.1.1 SCI format 2-A
SCI format 2-A is used for the decoding of PSSCH, with HARQ operation when HARQ-ACK information includes
ACK or NACK, when HARQ-ACK information includes only NACK, or when there is no feedback of HARQ-ACK
information.
The following information is transmitted by means of the SCI format 2-A:

| | |
|---|---|
| - | HARQ process number - 4 bits as defined in clause 16.4 of [5, TS 38.213]. |
| - | New data indicator - 1 bit as defined in clause 16.4 of [5, TS 38.213]. |
| - | Redundancy version - 2 bits as defined in clause 16.4 of [6, TS 38.214]. |
| - | Source ID - 8 bits as defined in clause 8.1 of [6, TS 38.214]. |
| - | Destination ID - 16 bits as defined in clause 8.1 of [6, TS 38.214]. |
| - | HARQ feedback enabled/disabled indicator - 1 bit as defined in clause 16.3 of [5, TS 38.213]. |
| - | Cast type indicator - 2 bits as defined in Table 8.4.1.1-1. |
| - | CSI request - 1 bit as defined in clause 8.2.1 of [6, TS 38.214]. |

Table 8.4.1.1-1: Cast type indicator

| Value of Cast type | |
|---|---|
| indicator | Cast type |
| 00 | Broadcast |
| 01 | Groupcast |
| | when HARQ-ACK information includes ACK |
| | or NACK |
| 10 | Unicast |
| 11 | Groupcast |
| | when HARQ-ACK information includes only |
| | NACK |

8.4.1.2 SCI format 2-B
SCI format 2-B is used for the decoding of PSSCH, with HARQ operation when HARQ-ACK information includes
only NACK, or when there is no feedback of HARQ-ACK information.
The following information is transmitted by means of the SCI format 2-B:

| | |
|---|---|
| - | HARQ process number - 4 bits as defined in clause 16.4 of [5, TS 38.213]. |
| - | New data indicator - 1 bit as defined in clause 16.4 of [5, TS 38.213]. |
| - | Redundancy version - 2 bits as defined in clause 16.4 of [6, TS 38.214]. |
| - | Source ID - 8 bits as defined in clause 8.1 of [6, TS 38.214] |
| - | Destination ID - 16 bits as defined in clause 8.1 of [6, TS 38.214]. |
| - | HARQ feedback enabled/disabled indicator - 1 bit as defined in clause 16.3 of [5, TS 38.213]. |
| - | Zone ID - 12 bits as defined in clause 5.8.11 of [9, TS 38.331]. |
| - | Communication range requirement - 4 bits determined by higher layer parameter sl-ZoneConfigMCR-Index. |

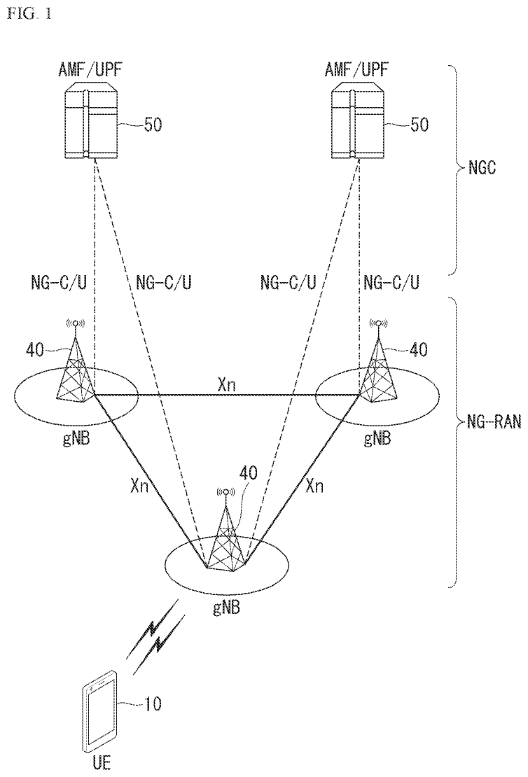

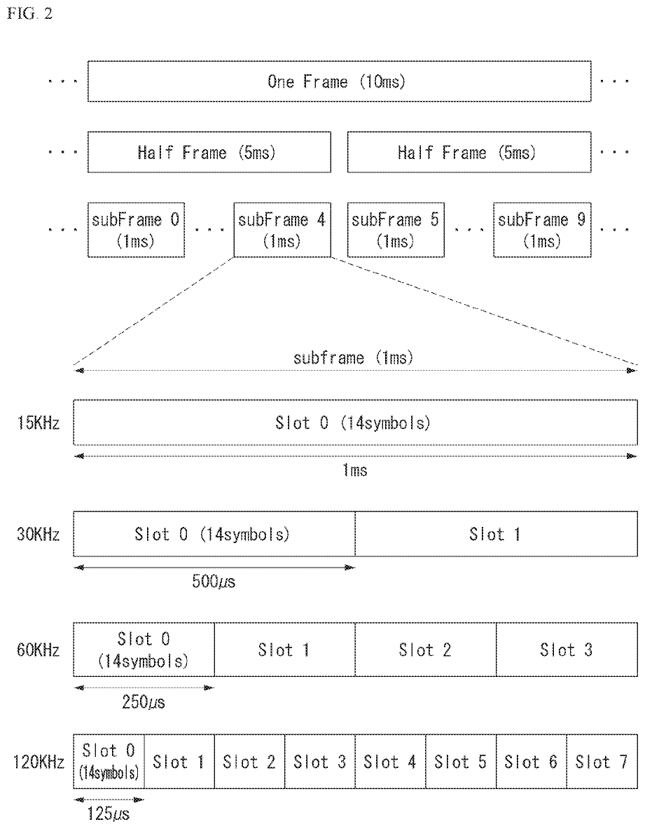

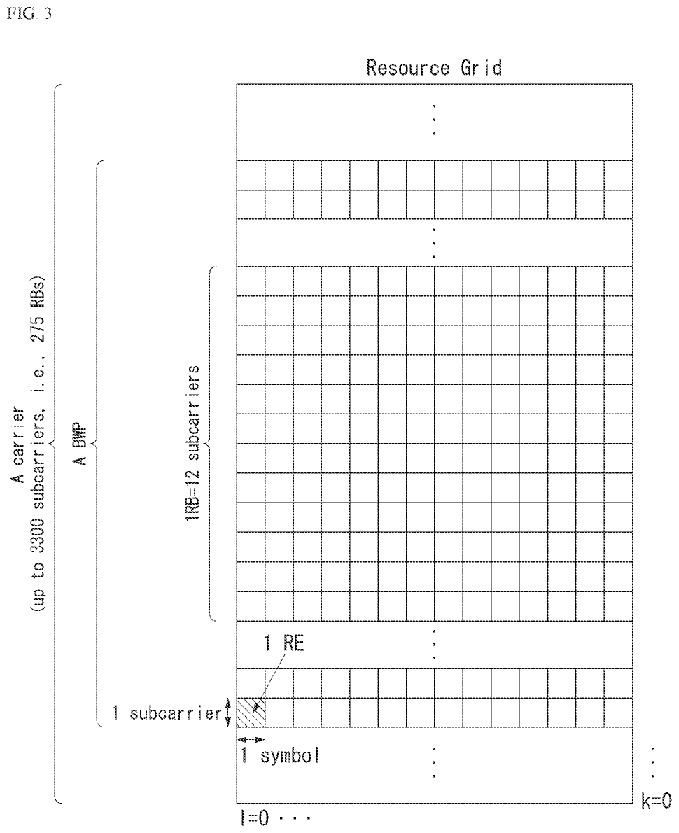

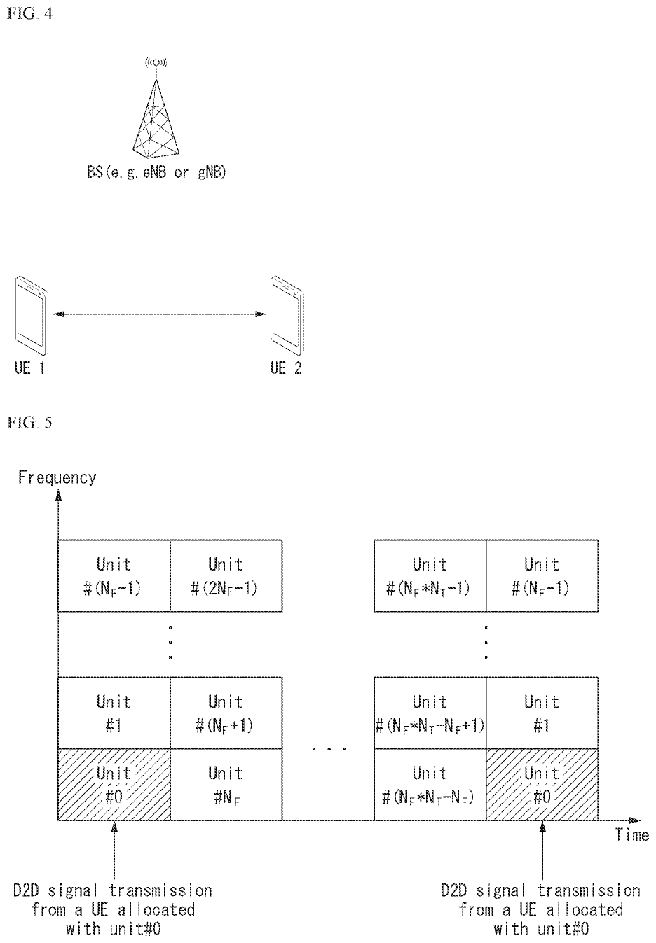

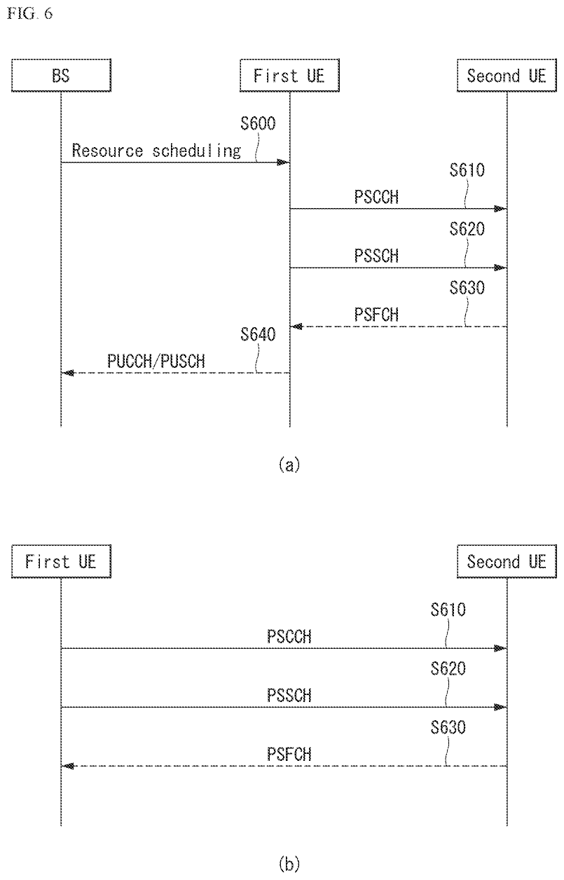

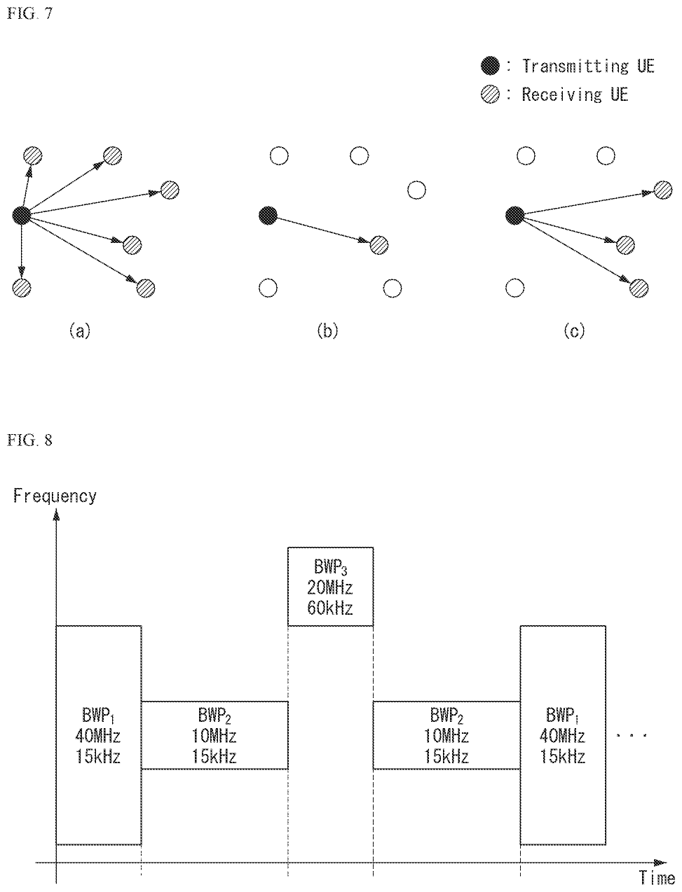

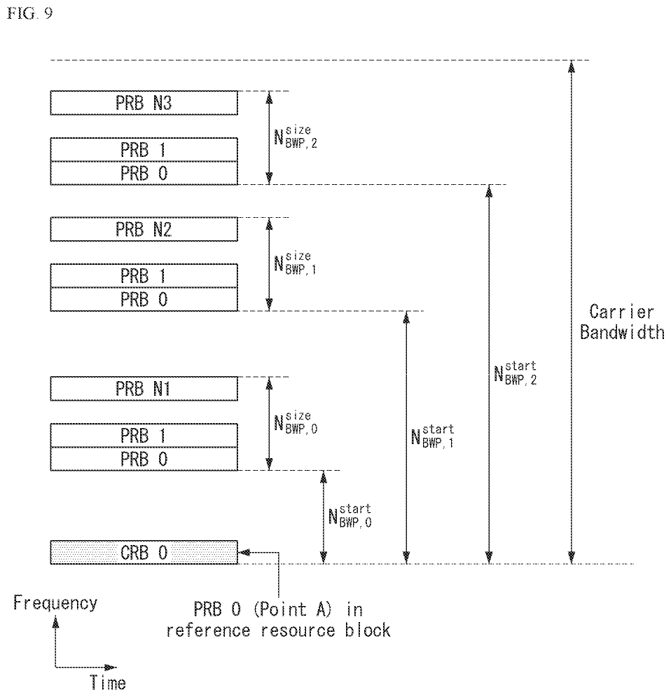

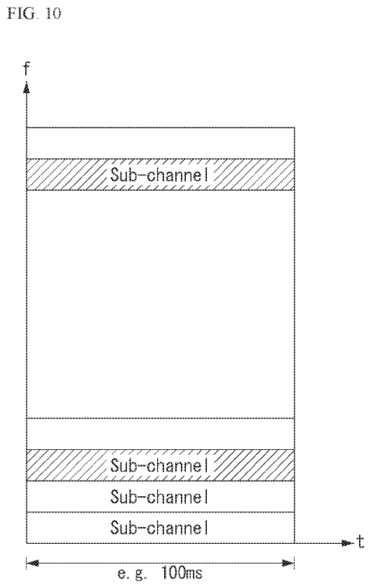

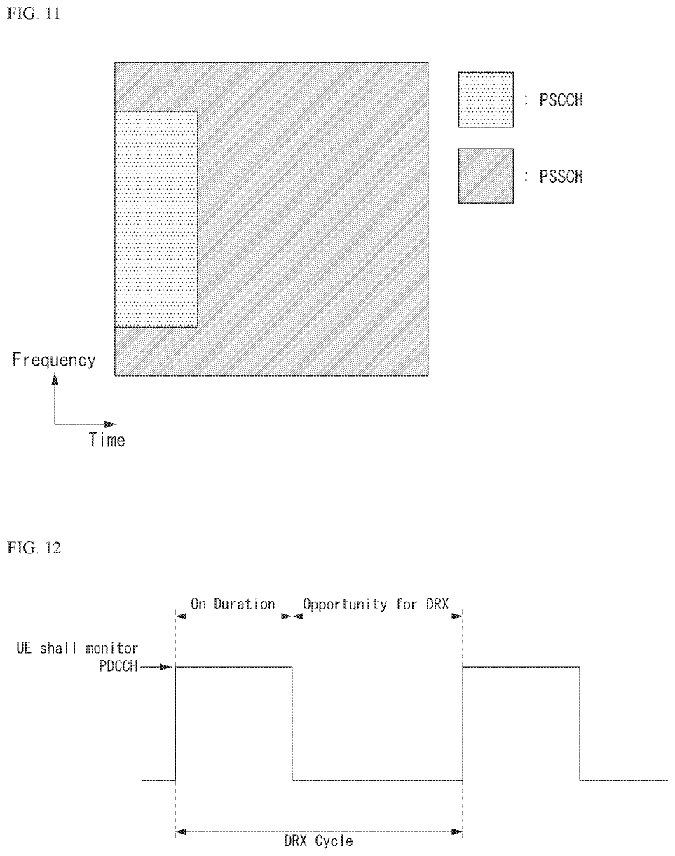

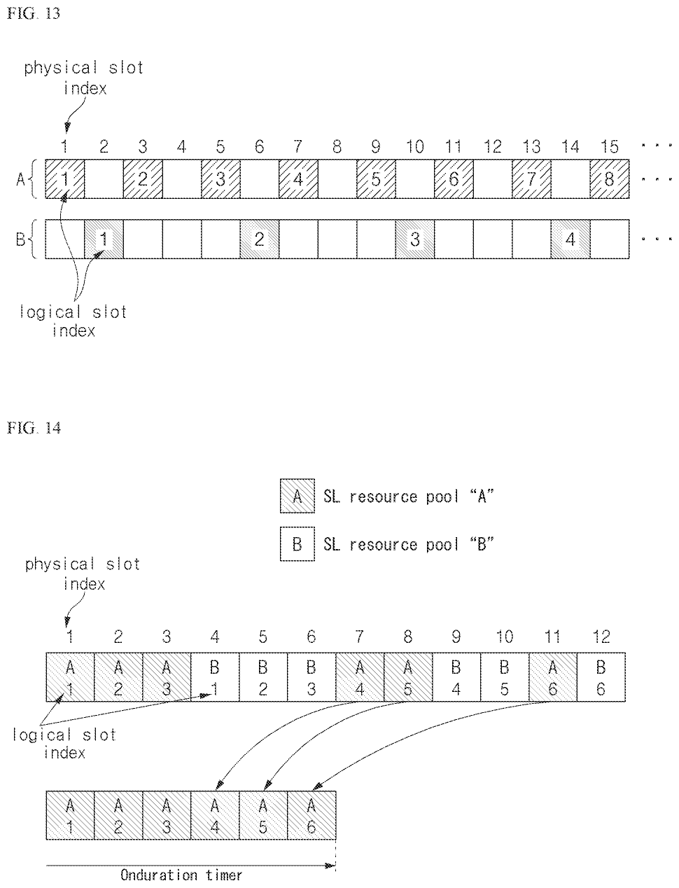

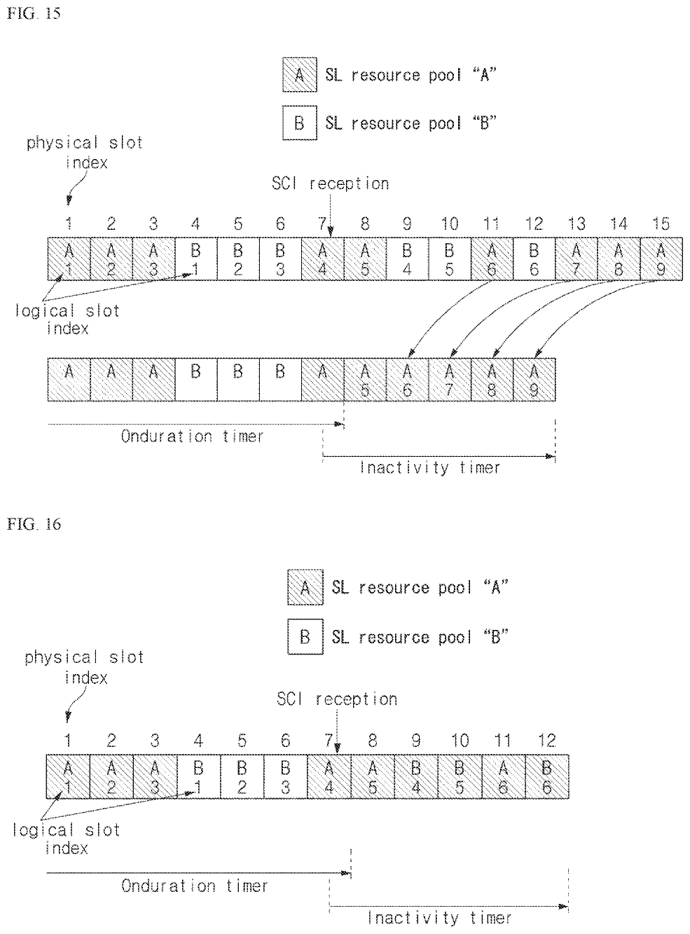

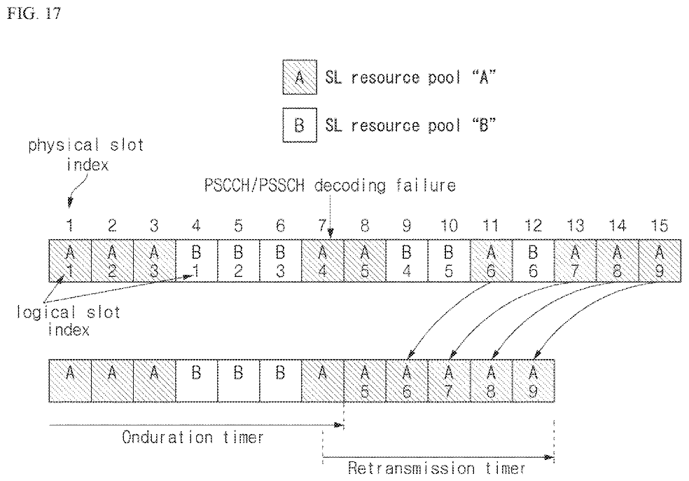

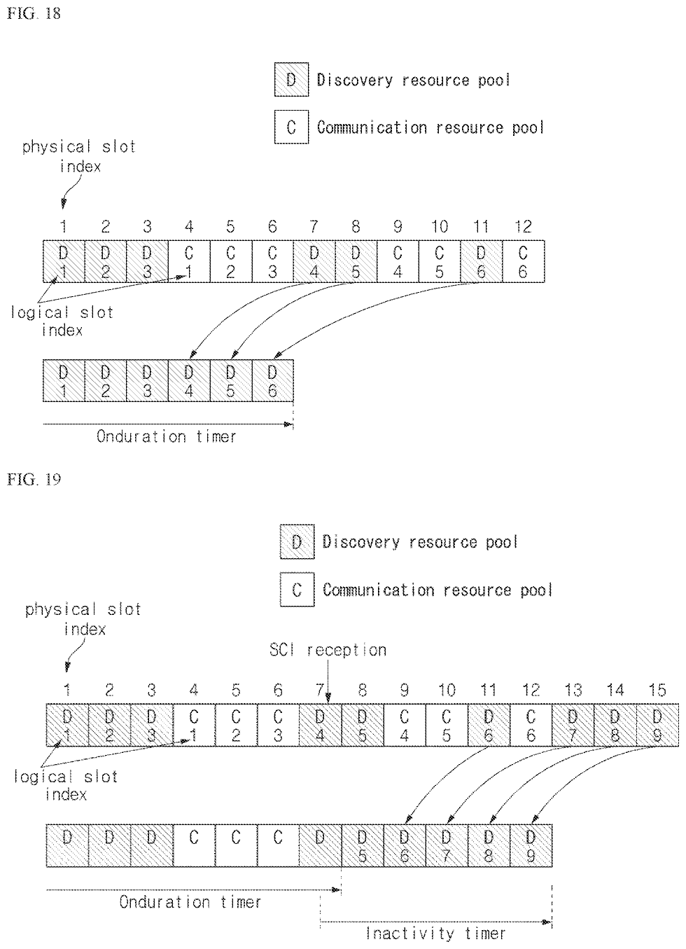

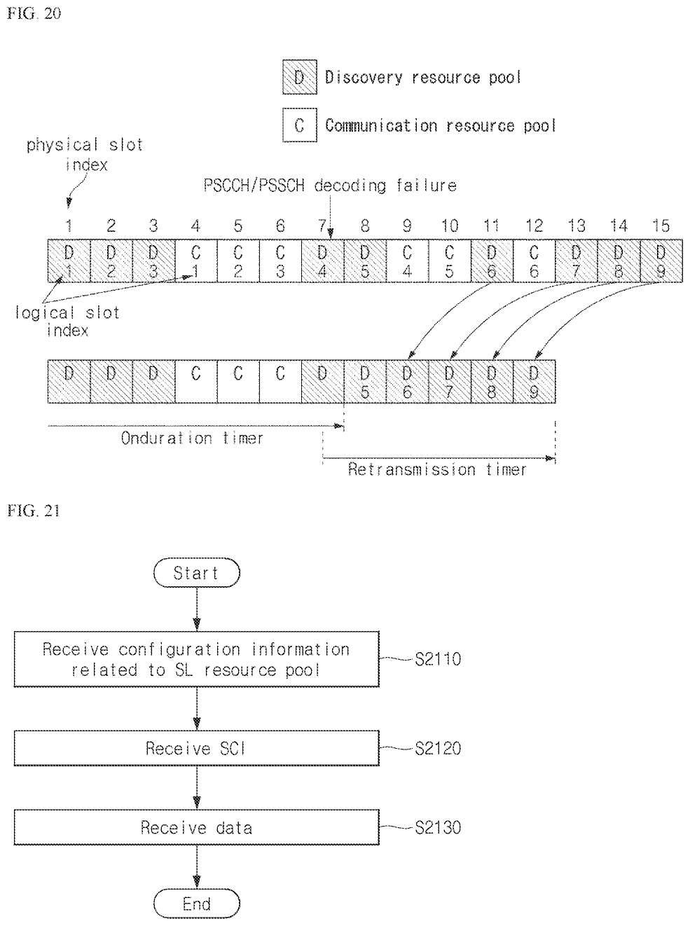

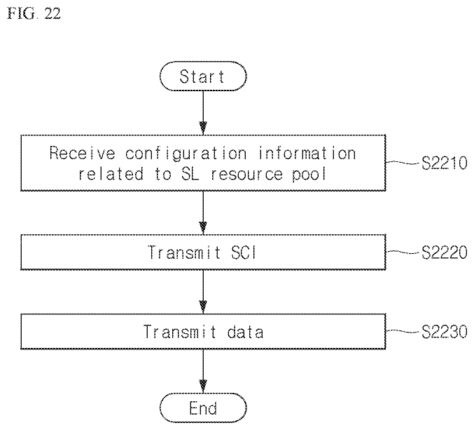

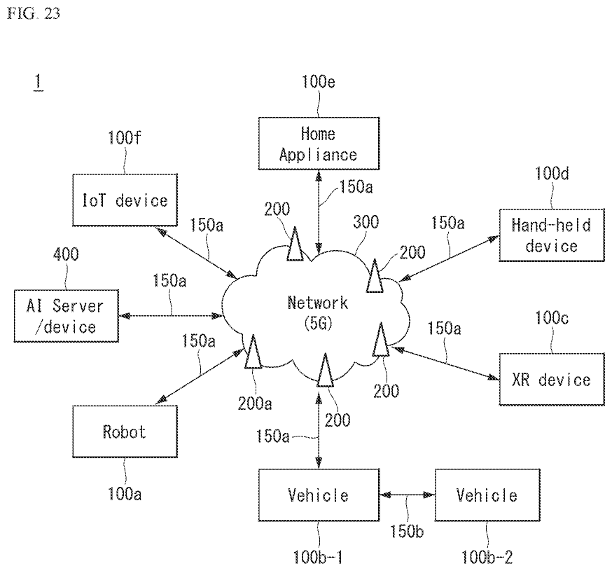

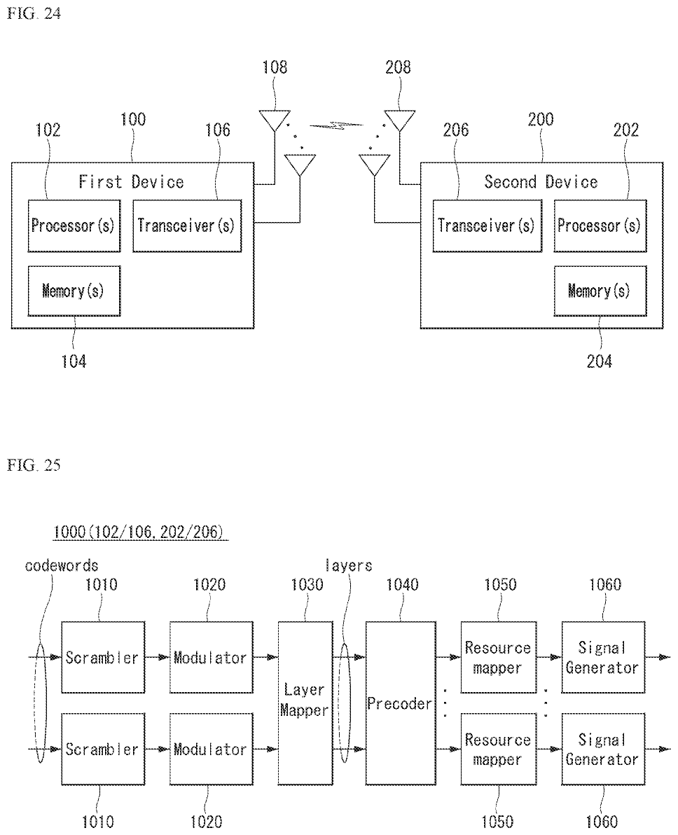

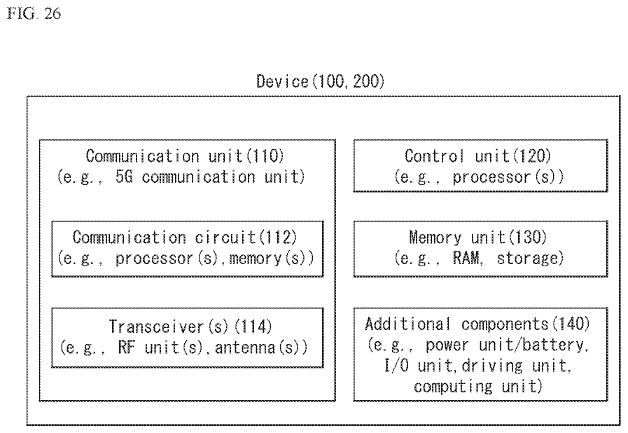

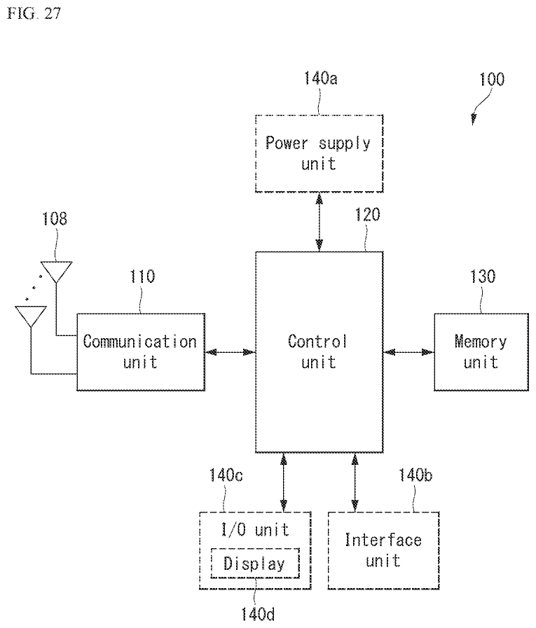

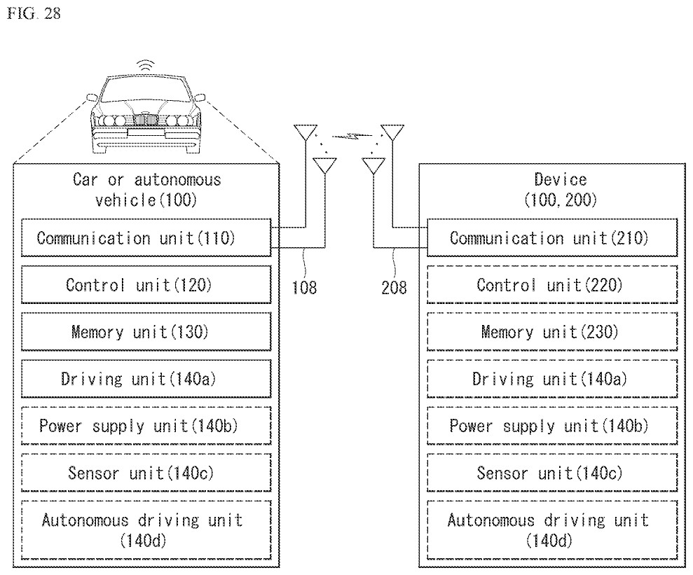

Referring to (a) or (b) of FIG. 29, in step S8030, the first UE may receive the PSPCH based on Table Z11. For example, the first UE and the second UE may determine a PSFCH resource based on Table Z11, and the second UE may transmit HARQ feedback to the first UE using the PSFCH resource.

TABLE Z11
3GPP TS 38.213

| 16.3 UE procedure for reporting HARQ-ACK on sidelink | |
|---|---|
| A UE can be indicated by an SCI format scheduling a PSSCH reception, in one or more sub-channels from a number | |
| of N_{subch}^{PSSCH} sub-channels, to transmit a PSFCH with HARQ-ACK information in response to the PSSCH reception. | |
| The UE provides HARQ-ACK information that includes ACK or NACK, or only NACK. | |
| A UE can be provided, by sl-PSFCH-Period-r16, a number of slots in a resource pool for a period of PSFCH | |
| transmission occasion resources. If the number is zero, PSFCH transmissions from the UE in the resource pool are | |
| disabled. | |
| A UE expects that a slot t′ₖ^{SL} (0 ≤ k < T′ₘₐₓ) has a PSFCH transmission occasion resource if k mod N_{PSSCH}^{PSFCH} = 0, | |
| where t′ₖ^{SL} is defined in [6, TS 38.214], and T′ₘₐₓ is a number of slots that belong to the resource pool within 10240 | |
| msec according to [6, TS 38.214], and N_{PSSCH}^{PSFCH} is provided by sl-PSFCH-Period-r16. | |
| A UE may be indicated by higher layers to not transmit a PSFCH in response to a PSSCH reception [11, TS 38.321]. | |
| If a UE receives a PSSCH in a resource pool and the HARQ feedback enabled/disabled indicator field in an associated | |
| SCI format 2-A or a SCI format 2-B has value 1 [5, TS 38.212], the UE provides the HARQ-ACK information in a | |
| PSFCH transmission in the resource pool. The UE transmits the PSFCH in a first slot that includes PSFCH resources | |
| and is at least a number of slots, provided by sl-MinTimeGapPSFCH-r16, of the resource pool after a last slot of the | |
| PSSCH reception. | |
| A UE is provided by sl-PSFCH-RB-Set-r16 a set of M_{PRB, set}^{PSFCH} PRBs in a resource pool for PSFCH transmission in a | |
| PRB of the resource pool. For a number of N_{subch} sub-channels for the resource pool, provided by sl-NumSubchannel, | |
| and a number of PSSCH slots associated with a PSFCH slot that is less than or equal to N_{PSSCH}^{PFSCH}, the UE allocates the | |
| [(i + j · N_{PSSCH}^{PSFCH}) · M_{subch, slot}^{PSFCH}, (i + 1 + j · N_{PSSCH}^{PSFCH}) · M_{subch, slot}^{PSFCH} − 1] PRBs from the M_{PRB, set}^{PSFCH} PRBs to slot i among | |
| the PSSCH slots associated with the PSFCH slot and sub-channel j, where M_{subch, slot}^{PSFCH} = M_{PRB, set}^{PSFCH}/(N_{subch} · N_{PSSCH}^{PSFCH}), | |
| 0 ≤ i < N_{PSSCH}^{PSFCH}, 0 ≤ j < N_{subch}, and the allocation starts in an ascending order of i and continues in an ascending | |
| order of j. The UE expects that M_{PRB, set}^{PSFCH} is a multiple of N_{subch} · N_{PSSCH}^{PSFCH}. | |
| A UE determines a number of PSFCH resources available for multiplexing HARQ-ACK information in a PSFCH | |
| transmission as R_{PRB, CS}^{PSFCH} = N_{type}^{PSFCH} · M_{subch, slot}^{PSFCH} · N_{CS}^{PSFCH} is a number of cyclic shift pairs for the | |
| resource pool and, based on an indication by higher layers, | |
| - | N_{type}^{PSFCH} = 1 and the M_{subch, slot}^{PSFCH} PRBs are associated with the starting sub-channel of the corresponding PSSCH |
| - | N_{type}^{PSFCH} = N_{subch}^{PSSCH} and the N_{subch}^{PSSCH} · M_{subch, slot}^{PSFCH} PRBs are associated with one or more sub-channels from the |
| | N_{subch}^{PSSCH} sub-channels of the corresponding PSSCH |

The PSFCH resources are first indexed according to an ascending order of the PRB index, from the N_{type}^{PSFCH} · M_{subch, slot}^{PSFCH}
PRBs, and then according to an ascending order of the cyclic shift pair index from the N_{CS}^{PSFCH} cyclic shift pairs.
A UE determines an index of a PSFCH resource for a PSFCH transmission in response to a PSSCH reception as
(P_{ID} + M_{ID})modR_{PRB, CS}^{PSFCH} where P_{ID} is a physical layer source ID provided by SCI format 2-A or 2-B [5, TS 38.212]
scheduling the PSSCH reception, and M_{ID} is the identity of the UE receiving the PSSCH as indicated by higher
layers if the UE detects a SCI format 2-A with Cast type indicator field value of “01”; otherwise, M_{ID} is zero.
A UE determines a m₀ value, for computing a value of cyclic shift α [4, TS 38.211], from a cyclic shift pair index
corresponding to a PSFCH resource index and from N_{CS}^{PSFCH} using Table 16.3-1.

Table 16.3-1: Set of cyclic shift pairs

| | m₀ | | | | | |
|---|---|---|---|---|---|---|
| | Cyclic Shift | Cyclic Shift | Cyclic Shift | Cyclic Shift | Cyclic Shift | Cyclic Shift |
| N_{CS}^{PSFCH} | Pair Index 0 | Pair Index 1 | Pair Index 2 | Pair Index 3 | Pair Index 4 | Pair Index 5 |
| 1 | 0 | — | — | — | — | — |
| 2 | 0 | 3 | — | — | — | — |
| 3 | 0 | 2 | 4 | — | — | — |
| 6 | 0 | 1 | 2 | 3 | 4 | 5 |

A UE determines a m_{cs} value, for computing a value of cyclic shift a [4, TS 38.211], as in Table 16.3-2 if the UE
detects a SCI format 2-A with Cast type indicator field value of “01” or “10”, or as in Table 16.3-3 if the UE detects a
SCI format 2-B or a SCI format 2-A with Cast type indicator field value of “11”. The UE applies one cyclic shift from
a cyclic shift pair to a sequence used for the PSFCH transmission [4, TS 38.211].

| | | |
|---|---|---|
| HARQ-ACK Value | 0 (NACK) | 1 (ACK) |

Table 16.3-2: Mapping of HARQ-ACK information bit values to a cyclic shift, from a cyclic shift pair,
of a sequence for a PSFCH transmission when HARQ-ACK information includes ACK or NACK

| | | |
|---|---|---|
| Sequence cyclic shift | 0 | 6 |

Table 16.3-3: Mapping of HARQ-ACK information bit values to a cyclic shift, from a cyclic shift pair,
of a sequence for a PSFCH transmission when HARQ-ACK information includes only NACK

| | | |
|---|---|---|
| Sequence cyclic shift | 0 | N/A |

Referring to (a) of FIG. Z9, in step S8040, the first UE may transmit SL HARQ feedback to the base station through the PUCCH and/or the PUSCH based on Table Z12.

TABLE Z12
3GPP TS 38.213

16.5 UE procedure for reporting HARQ-ACK on uplink
A UE can be provided PUCCH resources or PUSCH resources [12, TS 38.331] to report HARQ-ACK information that
the UE generates based on HARQ-ACK information that the UE obtains from PSFCH receptions, or from absence of
PSFCH receptions. The UE reports HARQ-ACK information on the primary cell of the PUCCH group, as described in
Clause 9, of the cell where the UE monitors PDCCH for detection of DCI format 3_0.
For SL configured grant Type 1 or Type 2 PSSCH transmissions by a UE within a time period provided by sl-
PeriodCG, the UE generates one HARQ-ACK information bit in response to the PSFCH receptions to multiplex in a
PUCCH transmission occasion that is after a last time resource, in a set of time resources.
For PSSCH transmissions scheduled by a DCI format 3_0, a UE generates HARQ-ACK information in response to
PSFCH receptions to multiplex in a PUCCH transmission occasion that is after a last time resource in a set of time
resources provided by the DCI format 3_0.
For each PSFCH reception occasion, from a number of PSFCH reception occasions, the UE generates HARQ-ACK
information to report in a PUCCH or PUSCH transmission. The UE can be indicated by a SCI format to perform one
of the following and the UE constructs a HARQ-ACK codeword with HARQ-ACK information, when applicable

| - | if the UE receives a PSFCH associated with a SCI format 2-A with Cast type indicator field value of “10” | |
|---|---|---|
| | - | generate HARQ-ACK information with same value as a value of HARQ-ACK information the UE |
| | | determines from a PSFCH reception in the PSFCH reception occasion and, if the UE determines that a |
| | | PSFCH is not received at the PSFCH reception occasion, generate NACK |
| - | if the UE receives a PSFCH associated with a SCI format 2-A with Cast type indicator field value of “01” | |
| | - | generate ACK if the UE determines ACK from at least one PSFCH reception occasion, from the number of |
| | | PSFCH reception occasions, in PSFCH resources corresponding to every identity MID of the UEs that the |
| | | UE expects to receive the PSSCH, as described in Clause 16.3; otherwise, generate NACK |
| - | if the UE receives a PSFCH associated with a SCI format 2-B or a SCI format 2-A with Cast type indicator | |
| | field value of “11” | |
| | - | generate ACK when the UE determines absence of PSFCH reception for each PSFCH reception occasion |

from the number of PSFCH reception occasions; otherwise, generate NACK

After a UE transmits PSSCHs and receives PSFCHs in corresponding PSFCH resource occasions, the priority value of
HARQ-ACK information is same as the priority value of the PSSCH transmissions that is associated with the PSFCH
reception occasions providing the HARQ-ACK information.
The UE generates a NACK when, due to prioritization, as described in Clause 16.2.4, the UE does not receive PSFCH
in any PSFCH reception occasion associated with a PSSCH transmission in a resource provided by a DCI format 3_0
with CRC scrambled by a SL-RNTI or, for a configured grant, in a resource provided in a single period and for which
the UE is provided a PUCCH resource to report HARQ-ACK information. The priority value of the NACK is same as
the priority value of the PSSCH transmission.
The UE generates a NACK when, due to prioritization as described in Clause 16.2.4, the UE does not transmit a
PSSCH in any of the resources provided by a DCI format 3_0 with CRC scrambled by SL-RNTI or, for a configured
grant, in any of the resources provided in a single period and for which the UE is provided a PUCCH resource to report
HARQ-ACK information. The priority value of the NACK is same as the priority value of the PSSCH that was not
transmitted due to prioritization.
The UE generates an ACK if the UE does not transmit a PSCCH with a SCI format 1-A scheduling a PSSCH in any of
the resources provided by a configured grant in a single period and for which the UE is provided a PUCCH resource to
report HARQ-ACK information. The priority value of the ACK is same as the largest priority value among the
possible priority values for the configured grant.
A UE does not expect to be provided PUCCH resources or PUSCH resources to report HARQ-ACK information that
start earlier than (N + 1) · (2048 + 144) · K · 2 · Tc after the end of a last symbol of a last PSFCH reception
occasion, from a number of PSFCH reception occasions that the UE generates HARQ-ACK information to report in a
PUCCH or PUSCH transmission, where

| | |
|---|---|
| - | κ and T_{c} are defined in [4, TS 38.211] |
| - | μ = min (μ_{SL}, μ_{U}L), where μ_{SL} is the SCS configuration of the SL BWP and μ_{UL} is the SCS configuration of |
| | the active UL BWP on the primary cell |
| - | N is determined from μ according to Table 16.5-1 |

Table 16.5-1: Values of N

| μ | N |
|---|---|
| 0 | 14 |
| 1 | 18 |
| 2 | 28 |
| 3 | 32 |

With reference to slots for PUCCH transmissions and for a number of PSFCH reception occasions ending in slot n,
the UE provides the generated HARQ-ACK information in a PUCCH transmission within slot n + k, subject to the
overlapping conditions in Clause 9.2.5, where k is a number of slots indicated by a PSFCH-to-HARQ_feedback
timing indicator field, if present, in a DCI format indicating a slot for PUCCH transmission to report the HARQ-ACK
information, or k is provided by sl-PSFCH-ToPUCCH-CG-Type1-r16. k = 0 corresponds to a last slot for a
PUCCH transmission that would overlap with the last PSFCH reception occasion assuming that the start of the sidelink
frame is same as the start of the downlink frame [4, TS 38.211].
For a PSSCH transmission by a UE that is scheduled by a DCI format, or for a SL configured grant Type 2 PSSCH
transmission activated by a DCI format, the DCI format indicates to the UE that a PUCCH resource is not provided
when a value of the PUCCH resource indicator field is zero and a value of PSFCH-to-HARQ feedback timing
indicator field, if present, is zero. For a SL configured grant Type 1 PSSCH transmission, a PUCCH resource can be
provided by sl-NIPUCCH-AN-r16 and sl-PSFCH-ToPUCCH-CG-Type1-r16. If a PUCCH resource is not provided,
the UE does not transmit a PUCCH with generated HARQ-ACK information from PSFCH reception occasions.
For a PUCCH transmission with HARQ-ACK information, a UE determines a PUCCH resource after determining a
set of PUCCH resources for O_{UCI} HARQ-ACK information bits, as described in Clause 9.2.1. The PUCCH resource
determination is based on a PUCCH resource indicator field [5, TS 38.212] in a last DCI format 3_0, among the DCI
formats 3_0 that have a value of a PSFCH-to-HARQ_feedback timing indicator field indicating a same slot for the
PUCCH transmission, that the UE detects and for which the UE transmits corresponding HARQ-ACK information in
the PUCCH where, for PUCCH resource determination, detected DCI formats are indexed in an ascending order across
PDCCH monitoring occasion indexes.
A UE does not expect to multiplex HARQ-ACK information for more than one SL configured grants in a same
PUCCH.
A priority value of a PUCCH transmission with one or more sidelink HARQ-ACK information bits is the smallest
priority value for the one or more HARQ-ACK information bits.
In the following, the CRC for DCI format 3_0 is scrambled with a SL-RNTI or a SL-CS-RNTI.

FIG. Z10 shows three cast types, based on an embodiment of the present disclosure. The embodiment of FIG. Z10 may be combined with various embodiments of the present disclosure.

Specifically. (a) of FIG. Z10 shows broadcast-type SL communication, (b) of FIG. Z10 shows unicast type-SL communication, and (c) of FIG. Z10 shows groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

Hereinafter, a hybrid automatic repeat request (HARQ) procedure will be described.

For example, the SL HARQ feedback may be enabled for unicast. In this case, in a non-code block group (non-CBG) operation, if the receiving UE decodes a PSCCH of which a target is the receiving UE and if the receiving UE successfully decodes a transport block related to the PSCCH, the receiving UE may generate HARQ-ACK. In addition, the receiving UE may transmit the HARQ-ACK to the transmitting UE. Otherwise, if the receiving UE cannot successfully decode the transport block after decoding the PSCCH of which the target is the receiving UE, the receiving UE may generate the HARQ-NACK. In addition, the receiving UE may transmit HARQ-NACK to the transmitting UE.

For example, the SL HARQ feedback may be enabled for groupcast. For example, in the non-CBG operation, two HARQ feedback options may be supported for groupcast.

(1) Groupcast option 1: After the receiving UE decodes the PSCCH of which the target is the receiving UE, if the receiving UE fails in decoding of a transport block related to the PSCCH, the receiving UE may transmit HARQ-NACK to the transmitting UE through a PSFCH. Otherwise, if the receiving UE decodes the PSCCH of which the target is the receiving UE and if the receiving UE successfully decodes the transport block related to the PSCCH, the receiving UE may not transmit the HARQ-ACK to the transmitting UE.

(2) Groupcast option 2: After the receiving UE decodes the PSCCH of which the target is the receiving UE, if the receiving UE fails in decoding of the transport block related to the PSCCH, the receiving UE may transmit HARQ-NACK to the transmitting UE through the PSFCH. In addition, if the receiving UE decodes the PSCCH of which the target is the receiving UE and if the receiving UE successfully decodes the transport block related to the PSCCH, the receiving UE may transmit the HARQ-ACK to the transmitting UE through the PSFCH.

For example, if the groupcast option 1 is used in the SL HARQ feedback, all UEs performing groupcast communication may share a PSFCH resource. For example, UEs belonging to the same group may transmit HARQ feedback by using the same PSFCH resource.

For example, if the groupcast option 2 is used in the SL HARQ feedback, each UE performing groupcast communication may use a different PSFCH resource for HARQ feedback transmission. For example, UEs belonging to the same group may transmit HARQ feedback by using different PSFCH resources.

In the present disclosure. HARQ-ACK may be referred to as ACK. ACK information, or positive-ACK information, and HARQ-NACK may be referred to as NACK. NACK information, or negative-ACK information.

Hereinafter. SL measurement and reporting will be described.

For the purpose of QoS prediction, initial transmission parameter setting, link adaptation, link management, admission control, or the like. SL measurement and reporting (e.g., RSRP, RSRQ) between UEs may be considered in SL. For example, a receiving UE may receive a reference signal from a transmitting UE, and the receiving UE may measure a channel state for the transmitting UE based on the reference signal. In addition, the receiving UE may report channel state information (CSI) to the transmitting UE. SL-related measurement and reporting may include measurement and reporting of CBR and reporting of location information. Examples of channel status information (CSI) for V2X may include a channel quality indicator (CQI), a precoding matrix index (PM), a rank indicator (RI), reference signal received power (RSRP), reference signal received quality (RSRQ), pathgain/pathloss, a sounding reference symbol (SRS) resource indicator (SRI), a SRI-RS resource indicator (CRI), an interference condition, a vehicle motion, or the like. In case of unicast communication. CQI. RI, and PMI or some of them may be supported in a non-subband-based aperiodic CSI report under the assumption of four or less antenna ports. A CSI procedure may not be dependent on a standalone reference signal (RS). A CSI report may be activated or deactivated based on a configuration.

For example, the transmitting UE may transmit CSI-RS to the receiving UE, and the receiving UE may measure CQI or RI based on the CSI-RS. For example, the CSI-RS may be referred to as SL CSI-RS. For example, the CSI-RS may be confined within PSSCH transmission. For example, the transmitting UE may perform transmission to the receiving UE by including the CSI-RS on the PSSCH.

Hereinafter, sidelink (SL) congestion control will be described.

For example, the UE may determine whether energy measured in a unit time/frequency resource is greater than or equal to a specific level, and may adjust an amount and frequency of use for its transmission resource based on a ratio of the unit time/frequency resource in which the energy greater than or equal to the specific level is observed. In the present disclosure, the ratio of the time/frequency resource in which the energy greater than or equal to the specific level is observed may be defined as a channel busy ratio (CBR). The UE may measure the CBR for a channel/frequency. Additionally, the UE may transmit the measured CBR to the network/BS.

FIG. Z11 shows a resource unit for CBR measurement based on an embodiment of the present disclosure. The embodiment of FIG. Z11 may be combined with various embodiments of the present disclosure.

Referring to FIG. Z11. CBR may denote the number of sub-channels in which a measurement result value of a received signal strength indicator (RSSI) has a value greater than or equal to a pre-configured threshold as a result of measuring the RSSI by a UE on a sub-channel basis for a specific period (e.g., 100 ms). Alternatively, the CBR may denote a ratio of sub-channels having a value greater than or equal to a pre-configured threshold among sub-channels for a specific duration. For example, in the embodiment of FIG. Z11, if it is assumed that a hatched sub-channel is a sub-channel having a value greater than or equal to a pre-configured threshold, the CBR may denote a ratio of the hatched sub-channels for a period of 100 ms. Additionally, the CBR may be reported to the BS.

For example, if a PSCCH and a PSSCH are multiplexed, the UE may perform one CBR measurement for one resource pool. Herein, if a PSFCH resource is configured or pre-configured, the PSFCH resource may be excluded in the CBR measurement.

Further, congestion control considering a priority of traffic (e.g. packet) may be necessary. To this end, for example, the UE may measure a channel occupancy ratio (CR). Specifically, the UE may measure the CBR, and the UE may determine a maximum value CRlimitk of a channel occupancy ratio k (CRk) that can be occupied by traffic corresponding to each priority (e.g., k) based on the CBR. For example, the UE may derive the maximum value CRlimitk of the channel occupancy ratio with respect to a priority of each traffic, based on a predetermined table of CBR measurement values. For example, in case of traffic having a relatively high priority, the UE may derive a maximum value of a relatively great channel occupancy ratio. Thereafter, the UE may perform congestion control by restricting a total sum of channel occupancy ratios of traffic, of which a priority k is lower than i, to a value less than or equal to a specific value. Based on this method, the channel occupancy ratio may be more strictly restricted for traffic having a relatively low priority.

In addition thereto, the UE may perform SL congestion control by using a method of adjusting a level of transmit power, dropping a packet, determining whether retransmission is to be performed, adjusting a transmission RB size (MCS coordination), or the like.

Table Z13 shows an example of SL CBR and SL RSSI.

TABLE Z13
SL CBR

| | |
|---|---|
| Definition | SL Channel Busy Ratio (SL CBR) measured in slot n is defined as the portion of sub-channels in |
| | the resource pool whose SL RSSI measured by the UE exceed a (pre-)configured threshold |
| | sensed over a CBR measurement window [n − a, n − 1], wherein a is equal to 100 or 100 · 2^{μ} slots, |
| | according to higher layer parameter timeWindowSize-CBR. |
| Applicable for | RRC_IDLE intra-frequency, |
| | RRC_IDLE inter-frequency, |
| | RRC_CONNECTED intra-frequency, |
| | RRC_CONNECTED inter-frequency |

SL RSSI

| | |
|---|---|
| Definition | Sidelink Received Signal Strength Indicator (SL RSSI) is defined as the linear average of the |
| | total received power (in [W]) observed in the configured sub-channel in OFDM symbols of a slot |
| | configured for PSCCH and PSSCH, starting from the 2^{nd} OFDM symbol. |
| | For frequency range 1, the reference point for the SL RSSI shall be the antenna connector of the |
| | UE. For frequency range 2, SL RSSI shall be measured based on the combined signal from |
| | antenna elements corresponding to a given receiver branch. For frequency range 1 and 2, if |
| | receiver diversity is in use by the UE, the reported SL RSSI value shall not be lower than the |
| | corresponding SL RSSI of any of the individual receiver branches. |
| Applicable for | RRC_IDLE intra-frequency, |
| | RRC_IDLE inter-frequency, |
| | RRC_CONNECTED intra-frequency, |
| | RRC_CONNECTED inter-frequency |

Referring to Table Z13, the slot index may be based on a physical slot index.

Table Z14 shows an example of SL Channel Occupancy Ratio (CR).

TABLE Z14

| | |
|---|---|
| Definition | Sidelink Channel Occupancy Ratio (SL CR) evaluated at slot n is defined as the total number of |
| | sub-channels used for its transmissions in slots [n − a, n − 1] and granted in slots [n, n + b] divided by |
| | the total number of configured sub-channels in the transmission pool over [n − a, n + b]. |
| Applicable for | RRC_IDLE intra-frequency, |
| | RRC_IDLE inter-frequency, |
| | RRC_CONNECTED intra-frequency, |
| | RRC_CONNECTED inter-frequency |

NOTE 1:
α is a positive integer and b is 0 or a positive integer; α and b are determined by UE implementation with α + b + 1 = 1000 or 1000 · 2^{μ} slots, according to higher layer parameter time WindowSize-CR, b < (a + b + 1)/2, and n + b shall not exceed the last transmission opportunity of the grant for the current transmission.
NOTE 2:
SL CR is evaluated for each (re)transmission.
NOTE 3:
In evaluating SL CR, the UE shall assume the transmission parameter used at slot n is reused according to the existing grant(s) in slot [n + 1, n + b] without packet dropping.
NOTE 4:
The slot index is based on physical slot index.
NOTE 5:
SL CR can be computed per priority level
NOTE 6:
A resource is considered granted if it is a member of a selected sidelink grant as defined in TS 38.321 [7].

Hereinafter, positioning will be described.

FIG. D1 shows an example of an architecture of a 5G system capable of positioning a UE having access to a next generation-radio access network (NG-RAN) or an E-UTRAN based on an embodiment of the present disclosure.

Referring to FIG. D1, an AMF may receive a request for a location service related to a specific target UE from a different entity such as a gateway mobile location center (GMLC), or may determine to start the location service in the AMF itself instead of the specific target UE. Then, the AMF may transmit a location service request to a location management function (LMF). Upon receiving the location service request, the LMF may process the location service request and return a processing request including an estimated location or the like of the UE to the AMF. Meanwhile, if the location service request is received from the different entity such as GMLC other than the AMF, the AMF may transfer to the different entity the processing request received from the LMF.

A new generation evolved-NB (ng-eNB) and a gNB are network elements of NG-RAN capable of providing a measurement result for location estimation, and may measure a radio signal for a target UE and may transfer a resultant value to the LMF. In addition, the ng-eNB may control several transmission points (TPs) such as remote radio heads or PRS-dedicated TPs supporting a positioning reference signal (PRS)-based beacon system for E-UTRA.

The LMF may be connected to an enhanced serving mobile location centre (E-SMLC), and the E-SMLC may allow the LMF to access E-UTRAN. For example, the E-SMLC may allow the LMF to support observed time difference of arrival (OTDOA), which is one of positioning methods of E-UTRAN, by using downlink measurement obtained by a target UE through a signal transmitted from the gNB and/or the PRS-dedicated TPs in the E-UTRAN.

Meanwhile, the LMF may be connected to an SUPL location platform (SLP). The LMF may support and manage different location determining services for respective target UEs. The LMF may interact with a serving ng-eNB or serving gNB for the target UE to obtain location measurement of the UE. For positioning of the target UE, the LMF may determine a positioning method based on a location service (LCS) client type, a requested quality of service (QOS), UE positioning capabilities, gNB positioning capabilities, and ng-eNB positioning capabilities, or the like, and may apply such a positioning method to the serving gNB and/or the serving ng-eNB. In addition, the LMF may determine additional information such as a location estimation value for the target UE and accuracy of location estimation and speed. The SLP is a secure user plane location (SUPL) entity in charge of positioning through a user plane.

The UE may measure a downlink signal through NG-RAN, E-UTRAN, and/or other sources such as different global navigation satellite system (GNSS) and terrestrial beacon system (TBS), wireless local access network (WLAN) access points, Bluetooth beacons, UE barometric pressure sensors or the like. The UE may include an LCS application. The UE may communicate with a network to which the UE has access, or may access the LCS application through another application included in the UE. The LCS application may include a measurement and calculation function required to determine a location of the UE. For example, the UE may include an independent positioning function such as a global positioning system (GPS), and may report the location of the UE independent of NG-RAN transmission. Positioning information obtained independently as such may be utilized as assistance information of the positioning information obtained from the network.

FIG. D2 shows an example of implementing a network for measuring a location of a UE based on an embodiment of the present disclosure.

When the UE is in a connection management (CM)-IDLE state, if an AMF receives a location service request, the AMF may establish a signaling connection with the UE, and may request for a network trigger service to allocate a specific serving gNB or ng-eNB. Such an operational process is omitted in FIG. D2. That is, it may be assumed in FIG. D2 that the UE is in a connected mode. However, due to signaling and data inactivation or the like, the signaling connection may be released by NG-RAN while a positioning process is performed.

A network operation process for measuring a location of a UE will be described in detail with reference to FIG. D2. In step al, a 5GC entity such as GMLC may request a serving AMF to provide a location service for measuring a location of a target UE. However, even if the GMLC does not request for the location service, based on step 1b, the serving AMF may determine that the location service for measuring the location of the target UE is required. For example, to measure the location of the UE for an emergency call, the serving AMF may determine to directly perform the location service.

Thereafter, the AMF may transmit the location service request to an LMF based on step 2, and the LMF may start location procedures to obtain location measurement data or location measurement assistance data together with a serving ng-eNB and a serving gNB. Additionally, based on step 3b, the LMF may start location procedures for downlink positioning together with the UE. For example, the LMF may transmit assistance data defined in 3GPP TS 36.355, or may obtain a location estimation value or a location measurement value. Meanwhile, step 3b may be performed additionally after step 3a is performed, or may be performed instead of step 3a.

In step 4, the LMF may provide a location service response to the AMF. In addition, the location service response may include information on whether location estimation of the UE is successful and a location estimation value of the UE. Thereafter, if the procedure of FIG. D2 is initiated by step al, the AMF may transfer the location service response to a 5GC entity such as GMLC, and if the procedure of FIG. D2 is initiated by step 1b, the AMF may use the location service response to provide a location service related to an emergency call or the like.

FIG. D3 shows an example of a protocol layer used to support LTE positioning protocol (LPP) message transmission between an LMF and a UE based on an embodiment of the present disclosure.

An LPP PDU may be transmitted through a NAS PDU between an AMF and the UE.

Referring to FIG. D3, an LPP may be terminated between a target device (e.g., a UE in a control plane or an SUPL enabled terminal (SET) in a user plane) and a location server (e.g., an LMF in the control plane and an SLP in the user plane). The LPP message may be transferred in a form of a transparent PDU through an intermediary network interface by using a proper protocol such as an NG application protocol (NGAP) through an NG-control plane (NG-C) interface and NAS/RRC or the like through an NR-Uu interface. The LPP protocol may enable positioning for NR and LTE by using various positioning methods.

For example, based on the LPP protocol, the target device and the location server may exchange mutual capability information, assistance data for positioning, and/or location information. In addition, an LPP message may be used to indicate exchange of error information and/or interruption of the LPP procedure.

FIG. D4 shows an example of a protocol layer used to support NR positioning protocol A (NRPPa) PDU transmission between an LMF and an NG-RAN node based on an embodiment of the present disclosure.

The NRPPa may be used for information exchange between the NG-RAN node and the LMF. Specifically, the NRPPa may exchange an enhanced-cell ID (E-CID) for measurement, data for supporting an OTDOA positioning method, and a cell-ID, cell location ID, or the like for an NR cell ID positioning method, transmitted from the ng-eNB to the LMF. Even if there is no information on an associated NRPPa transaction, the AMF may route NRPPa PDUs based on a routing ID of an associated LMR through an NG-C interface.

A procedure of an NRPPa protocol for location and data collection may be classified into two types. A first type is a UE associated procedure for transferring information on a specific UE (e.g., location measurement information or the like), and a second type is a non UE associated procedure for transferring information (e.g., gNB/ng-eNB/TP timing information, etc.) applicable to an NG-RAN node and associated TPs. The two types of the procedure may be independently supported or may be simultaneously supported.

Meanwhile, examples of positioning methods supported in NG-RAN may include GNSS, OTDOA, enhanced cell ID (E-CID), barometric pressure sensor positioning, WLAN positioning, Bluetooth positioning and terrestrial beacon system (TBS), uplink time difference of arrival (UTDOA), etc.

(1) OTDOA (Observed Time Difference Of Arrival)

FIG. D5 is a drawing for explaining an OTDOA positioning method based on an embodiment of the present disclosure.

The OTDOA positioning method uses measurement timing of downlink signals received by a UE from an eNB, an ng-eNB, and a plurality of TPs including a PRS-dedicated TP. The UE measures timing of downlink signals received by using location assistance data received from a location server. In addition, a location of the UE may be determined based on such a measurement result and geometric coordinates of neighboring TPs.

A UE connected to a gNB may request for a measurement gap for OTDOA measurement from the TP. If the UE cannot recognize a single frequency network (SFN) for at least one TP in the OTDOA assistance data, the UE may use an autonomous gap to obtain an SNF of an OTDOA reference cell before the measurement gap is requested to perform reference signal time difference (RSTD) measurement.

Herein, the RSTD may be defined based on a smallest relative time difference between boundaries of two subframes received respectively from a reference cell and a measurement cell. That is, the RSTD may be calculated based on a relative time difference between a start time of a subframe received from the measurement cell and a start time of a subframe of a reference cell closest to the start time of the subframe received from the measurement cell. Meanwhile, the reference cell may be selected by the UE.

For correct OTDOA measurement, it may be necessary to measure a time of arrival (TOA) of a signal received from three or more TPs or BSs geometrically distributed. For example, a TOA may be measured for each of a TP1, a TP2, and a TP3, and RSTD for TP 1-TP 2. RSTD for TP 2-TP 3, and RSTD for TP 3-TP 1 may be calculated for the three TOAs. Based on this, a geometric hyperbola may be determined, and a point at which these hyperbolas intersect may be estimated as a location of a UE. In this case, since accuracy and/or uncertainty for each TOA measurement may be present, the estimated location of the UE may be known as a specific range based on measurement uncertainty.

For example, RSTD for two TPs may be calculated based on Equation D1.

$$RSTDi , 1 = \frac{\sqrt{{( {x}_{t} - {x}_{i} )}^{2} + {( {y}_{t} - {y}_{i} )}^{2}}}{c} - \frac{\sqrt{{( {x}_{t} - {x}_{1} )}^{2} + {( {y}_{t} - {y}_{1} )}^{2}}}{c} + ( {T}_{i} - {T}_{1} ) + ( {n}_{i} - {n}_{1} ) \qquad [ Equation D 1 ]$$

Herein, c may be the speed of light, {xₜ, yₜ} may be a (unknown) coordinate of a target UE. {xᵢ, yᵢ} may be a coordinate of a (known) TP, and {x₁, y₁} may be a coordinate of a reference TP (or another TP). Herein. (Tᵢ-T₁) may be referred to as “real time differences (RTDs)” as a transmission time offset between two TPs, and nᵢ, n₁ may represent values related to UE TOA measurement errors.

### (2) E-CID (Enhanced Cell ID)

In a cell ID (CID) positioning method, a location of a UE may be measured through geometric information of a serving ng-eNB, serving gNB, and/or serving cell of the UE. For example, the geometric information of the serving ng-eNB, serving gNB, and/or serving cell may be obtained through paging, registration, or the like.

Meanwhile, in addition to the CID positioning method, an E-CID positioning method may use additional UE measurement and/or NG-RAN radio resources or the like to improve a UE location estimation value. In the E-CID positioning method, although some of the measurement methods which are the same as those used in a measurement control system of an RRC protocol may be used, additional measurement is not performed in general only for location measurement of the UE. In other words, a measurement configuration or a measurement control message may not be provided additionally to measure the location of the UE. Also, the UE may not expect that an additional measurement operation only for location measurement will be requested, and may report a measurement value obtained through measurement methods in which the UE can perform measurement in a general manner.

For example, the serving gNB may use an E-UTRA measurement value provided from the UE to implement the E-CID positioning method.

Examples of a measurement element that can be used for E-CID positioning may be as follows.
UE measurement: E-UTRA reference signal received power (RSRP), E-UTRA reference signal received quality (RSRQ). UE E-UTRA Rx-Tx Time difference. GSM EDGE random access network (GERAN)/WLAN reference signal strength indication (RSSI). UTRAN common pilot channel (CPICH) received signal code power (RSCP). UTRAN CPICH Ec/Io
E-UTRAN measurement: ng-eNB Rx-Tx Time difference, timing advance (TADV), angle of arrival (AoA)

Herein, the TADV may be classified into Type 1 and Type 2 as follows.
TADV Type 1=(ng-eNB Rx-Tx time difference)+ (UE E-UTRA Rx-Tx time difference)
TADV Type 2=ng-eNB Rx-Tx time difference

Meanwhile. AoA may be used to measure a direction of the UE. The AoA may be defined as an estimation angle with respect to the location of the UE counterclockwise from a BS/TP. In this case, a geographic reference direction may be north. The BS/TP may use an uplink signal such as a sounding reference signal (SRS) and/or a demodulation reference signal (DMRS) for AoA measurement. In addition, the larger the arrangement of the antenna array, the higher the measurement accuracy of the AoA. When the antenna arrays are arranged with the same interval, signals received from adjacent antenna elements may have a constant phase-rotate.

### (3) UTDOA (Uplink Time Difference of Arrival)

UTDOA is a method of determining a location of a UE by estimating an arrival time of SRS. When calculating an estimated SRS arrival time, the location of the UE may be estimated through an arrival time difference with respect to another cell (or BS/TP) by using a serving cell as a reference cell. In order to implement the UTDOA. E-SMLC may indicate a serving cell of a target UE to indicate SRS transmission to the target UE. In addition, the E-SMLC may provide a configuration such as whether the SRS is periodical/aperiodical, a bandwidth, frequency/group/sequence hopping, or the like.

Referring to the standard document, some procedures and technical specifications related to the present disclosure are as follows.

TABLE 1
3GPP TS 38.321 V16.2.1

The MAC entity may be configured by RRC with a DRX functionality that controls the UE's PDCCH monitoring
activity for the MAC entity's C-RNTI, CI-RNTI, CS-RNTI, INT-RNTI, SFI-RNTI, SP-CSI-RNTI, TPC-PUCCH-
RNTI, TPC-PUSCH-RNTI, TPC-SRS-RNTI, and AI-RNTI. When using DRX operation, the MAC entity shall also
monitor PDCCH according to requirements found in other clauses of this specification. When in RRC_CONNECTED,
if DRX is configured, for all the activated Serving Cells, the MAC entity may monitor the PDCCH discontinuously
using the DRX operation specified in this clause; otherwise the MAC entity shall monitor the PDCCH as specified in
TS 38.213 [6].
NOTE 1: If Sidelink resource allocation mode 1 is configured by RRC, a DRX functionality is not configured.
RRC controls DRX operation by configuring the following parameters:

| | |
|---|---|
| - | drx-onDurationTimer: the duration at the beginning of a DRX cycle; |
| - | drx-SlotOffset: the delay before starting the drx-onDurationTimer; |
| - | drx-InactivityTimer: the duration after the PDCCH occasion in which a PDCCH indicates a new UL or DL |
| | transmission for the MAC entity; |
| - | drx-RetransmissionTimerDL (per DL HARQ process except for the broadcast process): the maximum duration |
| | until a DL retransmission is received; |
| - | drx-RetransmissionTimerUL (per UL HARQ process): the maximum duration until a grant for UL |
| | retransmission is received; |
| - | drx-LongCycleStartOffset: the Long DRX cycle and drx-StartOffset which defines the subframe where the Long |
| | and Short DRX cycle starts; |
| - | drx-ShortCycle (optional): the Short DRX cycle; |
| - | drx-ShortCycleTimer (optional): the duration the UE shall follow the Short DRX cycle; |
| - | drx-HARQ-RTT-TimerDL (per DL HARQ process except for the broadcast process): the minimum duration |
| | before a DL assignment for HARQ retransmission is expected by the MAC entity; |
| - | drx-HARQ-RTT-TimerUL (per UL HARQ process): the minimum duration before a UL HARQ retransmission |
| | grant is expected by the MAC entity; |
| - | ps-Wakeup (optional): the configuration to start associated drx-onDurationTimer in case DCP is monitored but |
| | not detected; |
| - | ps-TransmitOtherPeriodicCSI (optional): the configuration to report periodic CSI that is not L1-RSRP on |
| | PUCCH during the time duration indicated by drx-onDurationTimer in case DCP is configured but associated |
| | drx-onDurationTimer is not started; |
| - | ps-TransmitPeriodicL1-RSRP (optional): the configuration to transmit periodic CSI that is L1-RSRP on |
| | PUCCH during the time duration indicated by drx-onDurationTimer in case DCP is configured but associated |
| | drx-onDurationTimer is not started. |

Serving Cells of a MAC entity may be configured by RRC in two DRX groups with separate DRX parameters. When
RRC does not configure a secondary DRX group, there is only one DRX group and all Serving Cells belong to that one
DRX group. When two DRX groups are configured, each Serving Cell is uniquely assigned to either of the two groups.
The DRX parameters that are separately configured for each DRX group are: drx-onDurationTimer, drx-
InactivityTimer. The DRX parameters that are common to the DRX groups are: drx-SlotOffset, drx-
RetransmissionTimerDL, drx-RetransmissionTimerUL, drx-LongCycleStartOffset, drx-ShortCycle (optional), drx-
ShortCycleTimer (optional), drx-HARQ-RTT-TimerDL, and drx-HARQ-RTT-TimerUL.
When a DRX cycle is configured, the Active Time for Serving Cells in a DRX group includes the time while:

| | |
|---|---|
| - | drx-onDurationTimer or drx-InactivityTimer configured for the DRX group is running; or |
| - | drx-RetransmissionTimerDL or drx-RetransmissionTimerUL is running on any Serving Cell in the DRX group; |
| | or |
| - | ra-ContentionResolutionTimer (as described in clause 5.1.5) or msgB-ResponseWindow (as described in clause |
| | 5.1.4a) is running; or |
| - | a Scheduling Request is sent on PUCCH and is pending (as described in clause 5.4.4); or |
| - | a PDCCH indicating a new transmission addressed to the C-RNTI of the MAC entity has not been received |
| | after successful reception of a Random Access Response for the Random Access Preamble not selected by the |
| | MAC entity among the contention-based Random Access Preamble (as described in clauses 5.1.4 and 5.1.4a). |

When DRX is configured, the MAC entity shall:

| 1> | if a MAC PDU is received in a configured downlink assignment: | |
|---|---|---|
| | 2> | start the drx-HARQ-RTT-TimerDL for the corresponding HARQ process in the first symbol after the end of |
| | | the corresponding transmission carrying the DL HARQ feedback; |
| | 2> | stop the drx-RetransmissionTimerDL for the corresponding HARQ process. |
| 1> | if a MAC PDU is transmitted in a configured uplink grant and LBT failure indication is not received from lower | |
| | layers: | |
| | 2> | start the drx-HARQ-RTT-TimerUL for the corresponding HARQ process in the first symbol after the end of |
| | | the first repetition of the corresponding PUSCH transmission; |
| | 2> | stop the drx-RetransmissionTimerUL for the corresponding HARQ process. |
| 1> | if a drx-HARQ-RTT-TimerDL expires: | |
| | 2> | if the data of the corresponding HARQ process was not successfully decoded: |

| | |
|---|---|
| 3> | start the drx-RetransmissionTimerDL for the corresponding HARQ process in the first symbol after the |

expiry of drx-HARQ-RTT-TimerDL.

| 1> | if a drx-HARQ-RTT-TimerUL expires: | |
|---|---|---|
| | 2> | start the drx-RetransmissionTimerUL for the corresponding HARQ process in the first symbol after the |
| | | expiry of drx-HARQ-RTT-TimerUL. |
| 1> | if a DRX Command MAC CE or a Long DRX Command MAC CE is received: | |
| | 2> | stop drx-onDurationTimer for each DRX group; |
| | 2> | stop drx-InactivityTimer for each DRX group. |
| 1> | if drx-InactivityTimer for a DRX group expires: | |
| | 2> | if the Short DRX cycle is configured: |

| 3> | start or restart drx-ShortCycleTimer for this DRX group in the first symbol after the expiry of drx- |
|---|---|
| | InactivityTimer; |
| 3> | use the Short DRX cycle for this DRX group. |

| | |
|---|---|
| 2> | else: |

| | |
|---|---|
| 3> | use the Long DRX cycle for this DRX group. |

| 1> | if a DRX Command MAC CE is received: | |
|---|---|---|
| | 2> | if the Short DRX cycle is configured: |

| 3> | start or restart drx-ShortCycleTimer for each DRX group in the first symbol after the end of DRX |
|---|---|
| | Command MAC CE reception; |
| 3> | use the Short DRX cycle for each DRX group. |

| | |
|---|---|
| 2> | else: |

| | |
|---|---|
| 3> | use the Long DRX cycle for each DRX group. |

| 1> | if drx-ShortCycleTimer for a DRX group expires: | |
|---|---|---|
| | 2> | use the Long DRX cycle for this DRX group. |
| 1> | if a Long DRX Command MAC CE is received: | |
| | 2> | stop drx-ShortCycleTimer for each DRX group; |
| | 2> | use the Long DRX cycle for each DRX group. |
| 1> | if the Short DRX cycle is used for a DRX group, and [(SFN × 10) + subframe number] modulo (drx- | |
| | ShortCycle) = (drx-StartOffset) modulo (drx-ShortCycle): | |
| | 2> | start drx-onDurationTimer for this DRX group after drx-SlotOffset from the beginning of the subframe. |
| 1> | if the Long DRX cycle is used for a DRX group, and [(SFN × 10) + subframe number] modulo (drx-LongCycle) | |
| | = drx-StartOffset: | |
| | 2> | if DCP monitoring is configured for the active DL BWP as specified in TS 38.213 [6], clause 10.3: |

| 3> | if DCP indication associated with the current DRX cycle received from lower layer indicated to start |
|---|---|
| | drx-onDurationTimer, as specified in TS 38.213 [6]; or |
| 3> | if all DCP occasion(s) in time domain, as specified in TS 38.213 [6], associated with the current DRX |
| | cycle occurred in Active Time considering grants/assignments/DRX Command MAC CE/Long DRX |
| | Command MAC CE received and Scheduling Request sent until 4 ms prior to start of the last DCP |
| | occasion, or within BWP switching interruption length, or during a measurement gap, or when the MAC |
| | entity monitors for a PDCCH transmission on the search space indicated by recoverySearchSpaceId of |
| | the SpCell identified by the C-RNTI while the ra-Response Window is running (as specified in clause |
| | 5.1.4); or |
| 3> | if ps-Wakeup is configured with value true and DCP indication associated with the current DRX cycle |

| has not been received from lower layers: | |
|---|---|
| 4> | start drx-onDurationTimer after drx-SlotOffset from the beginning of the subframe. |

| | |
|---|---|
| 2> | else: |

| | |
|---|---|
| 3> | start drx-onDurationTimer for this DRX group after drx-SlotOffset from the beginning of the subframe. |

| | |
|---|---|
| NOTE 2: | In case of unaligned SFN across carriers in a cell group, the SFN of the SpCell is used to calculate the |
| | DRX duration. |

| 1> | if a DRX group is in Active Time: | |
|---|---|---|
| | 2> | monitor the PDCCH on the Serving Cells in this DRX group as specified in TS 38.213 [6]; |
| | 2> | if the PDCCH indicates a DL transmission: |

| | 3> | start the drx-HARQ-RTT-TimerDL for the corresponding HARQ process in the first symbol after the end |
|---|---|---|
| | | of the corresponding transmission carrying the DL HARQ feedback; |
| NOTE 3: | | When HARQ feedback is postponed by PDSCH-to-HARQ_feedback timing indicating a non-numerical |
| | | k1 value, as specified in TS 38.213 [6], the corresponding transmission opportunity to send the DL |
| | | HARQ feedback is indicated in a later PDCCH requesting the HARQ-ACK feedback. |
| | 3> | stop the drx-RetransmissionTimerDL for the corresponding HARQ process. |
| | 3> | if the PDSCH-to-HARQ_feedback timing indicate a non-numerical kl value as specified in TS 38.213 |

| [6]: | |
|---|---|
| 4> | start the drx-RetransmissionTimerDL in the first symbol after the PDSCH transmission for the |

corresponding HARQ process.

| | |
|---|---|
| 2> | if the PDCCH indicates a UL transmission: |

| 3> | start the drx-HARQ-RTT-TimerUL for the corresponding HARQ process in the first symbol after the end |
|---|---|
| | of the first repetition of the corresponding PUSCH transmission; |
| 3> | stop the drx-RetransmissionTimerUL for the corresponding HARQ process. |

| | |
|---|---|
| 2> | if the PDCCH indicates a new transmission (DL or UL) on a Serving Cell in this DRX group: |

| | |
|---|---|
| 3> | start or restart drx-InactivityTimer for this DRX group in the first symbol after the end of the PDCCH |

reception.

| | |
|---|---|
| 2> | if a HARQ process receives downlink feedback information and acknowledgement is indicated: |

| | |
|---|---|
| 3> | stop the drx-RetransmissionTimerUL for the corresponding HARQ process. |

| 1> | if DCP monitoring is configured for the active DL BWP as specified in TS 38.213 [6], clause 10.3; and | |
|---|---|---|
| 1> | if the current symbol n occurs within drx-onDurationTimer duration; and | |
| 1> | if drx-onDurationTimer associated with the current DRX cycle is not started as specified in this clause: | |
| | 2> | if the MAC entity would not be in Active Time considering grants/assignments/DRX Command MAC |

| CE/Long DRX Command MAC CE received and Scheduling Request sent until 4 ms prior to symbol n | |
|---|---|
| when evaluating all DRX Active Time conditions as specified in this clause: | |
| 3> | not transmit periodic SRS and semi-persistent SRS defined in TS 38.214 [7]; |
| 3> | not report semi-persistent CSI configured on PUSCH; |
| 3> | if ps-TransmitPeriodicLI-RSRP is not configured with value true: |

| | |
|---|---|
| 4> | not report periodic CSI that is L1-RSRP on PUCCH. |

| | |
|---|---|
| 3> | if ps-TransmitOtherPeriodicCSI is not configured with value true: |

| | |
|---|---|
| 4> | not report periodic CSI that is not L1-RSRP on PUCCH. |

| 1> | else: | |
|---|---|---|
| | 2> | in current symbol n, if a DRX group would not be in Active Time considering grants/assignments scheduled |

| on Serving Cell(s) in this DRX group and DRX Command MAC CE/Long DRX Command MAC CE | |
|---|---|
| received and Scheduling Request sent until 4 ms prior to symbol n when evaluating all DRX Active Time | |
| conditions as specified in this clause: | |
| 3> | not transmit periodic SRS and semi-persistent SRS defined in TS 38.214 [7] in this DRX group; |
| 3> | not report CSI on PUCCH and semi-persistent CSI configured on PUSCH in this DRX group. |

| | |
|---|---|
| 2> | if CSI masking (csi-Mask) is setup by upper layers: |

| | |
|---|---|
| 3> | in current symbol n, if drx-onDurationTimer of a DRX group would not be running considering |

| grants/assignments scheduled on Serving Cell(s) in this DRX group and DRX Command MAC CE/Long | |
|---|---|
| DRX Command MAC CE received until 4 ms prior to symbol n when evaluating all DRX Active Time | |
| conditions as specified in this clause; and | |
| 4> | not report CSI on PUCCH in this DRX group. |

| | |
|---|---|
| NOTE 4: | If a UE multiplexes a CSI configured on PUCCH with other overlapping UCI(s) according to the |
| | procedure specified in TS 38.213 [6] clause 9.2.5 and this CSI multiplexed with other UCI(s) would be |
| | reported on a PUCCH resource outside DRX Active Time of the DRX group in which this PUCCH is |
| | configured, it is up to UE implementation whether to report this CSI multiplexed with other UCI(s). |

Regardless of whether the MAC entity is monitoring PDCCH or not on the Serving Cells in a DRX group, the MAC
entity transmits HARQ feedback, aperiodic CSI on PUSCH, and aperiodic SRS defined in TS 38.214 [7] on the
Serving Cells in the DRX group when such is expected.
The MAC entity needs not to monitor the PDCCH if it is not a complete PDCCH occasion (e.g. the Active Time starts
or ends in the middle of a PDCCH occasion).

In Release 17 NR V2X, SideLink Discontinuous Reception (SL DRX) operation is supported. Embodiment(s) of the present disclosure proposes an SL DRX operation of a sidelink resource pool based UE. In the following description, the expression of “when, if, in case of” may be replaced by the expression of “based on”.

The present disclosure proposes a sidelink resource pool based SL DRX operation of a Tx UE and an Rx UE, as below.

The sidelink resource pool may be configured with a resource pool supporting the SL DRX operation and a resource pool not supporting the SL DRX operation.

For example, if a sidelink resource pool “A” and a sidelink resource pool “B” are configured with a sidelink resource pool (e.g., RX pool) used by an Rx UE, the sidelink resource pool “A” is a resource pool supporting a sidelink DRX operation, and the sidelink resource pool “B” is a resource pool not supporting the sidelink DRX operation, the sidelink DRX operation of the UE is proposed as below.

An Rx UE performs a monitoring reception operation of SL data while monitoring a sidelink resource pool (resource pools “A” and “B”).

If it is determined that the Rx UE will perform an SL DRX operation using the sidelink resource pool “A” based on a specific condition (indicated by a BS/Tx UE or the Rx UE selects a specific resource pool based on the specific condition being met), the Rx UE can perform the following SL DRX operation.

For example, if the Rx UE receives PSCCH/PSSCH transmitted by the Tx UE in SL slot “N” (SL slot included in the sidelink resource pool “A”), the Rx UE starts an SL DRX inactivity timer and extends a time duration (period) in which an active time operation can be performed. If SL slots belonging to the sidelink resource pool “B” are included in SL DRX inactivity timer duration, the Rx UE proposes to exclude the SL slots belonging to the sidelink resource pool “B” from counting of the SL DRX inactivity timer. That is, the SL DRX inactivity timer includes only sidelink slots of the resource pool “A” including a slot in which SCI or PSCCH/PSSCH is received (the SL DRX inactivity timer is filled with only the sidelink slots of the resource pool “A” as much as a length of the SL DRX inactivity timer). The operation described above can also be equally applied to an operation based on an SL retransmission timer.

In another embodiment, the Rx UE performs the SL DRX operation using configured SL DRX configuration (SL DRX configuration configured by the Tx UE or SL DRX configuration configured per QoS profile). For example, the Rx UE applies an On Duration timer of the configured SL DRX configuration to perform an SL DRX active time operation. The Rx UE proposes to perform an active time (active mode) operation in SL slots of the sidelink resource pool “A” (a resource pool in which the SL DRX operation is supported) within a sidelink DRX OnDuration timer duration, and to exclude SL slots of the sidelink resource pool “B” (a resource pool in which the SL DRX operation is not supported) from counting of the SL DRX OnDuration timer. That is, the SL DRX Onduration timer is filled with only the sidelink slots of the sidelink resource pool “A” (a resource pool in which the SL DRX operation is supported) as much as a length of the SL DRX Onduration timer.

The present disclosure also proposes the following embodiments. The Rx UE performs a monitoring reception operation of SL data while monitoring a sidelink resource pool (resource pools “A” and “B” and “C”) configured by the base station.
Resource pool “A”: Resource pool in which sidelink operation is supported
Resource pool “B”: Resource pool in which sidelink operation is not supported
Resource pool “C”: Resource pool in which sidelink operation is supported

If it is determined that the Rx UE will perform an SL DRX operation using the sidelink resource pool “A” based on a specific condition (indicated by a BS/Tx UE or the Rx UE selects a specific resource pool based on the specific condition being met), the Rx UE can perform the following SL DRX operation.

For example, if the Rx UE receives PSCCH/PSSCH transmitted by the Tx UE in SL slot “N” (SL slot included in the sidelink resource pool “A”), the Rx UE starts an SL DRX inactivity timer and extends a time duration in which an active time operation can be performed. If SL slots belonging to the sidelink resource pool “B” or “C” are included in SL DRX inactivity timer duration, the Rx UE proposes to exclude the SL slots belonging to the sidelink resource pool “B” (a resource pool in which the SL DRX operation is not supported) or the sidelink resource pool “C” (a resource pool in which the SL DRX operation is supported, but which is not selected by the Rx UE for the DRX operation) from counting of the SL DRX inactivity timer. That is, the SL DRX inactivity timer includes only sidelink slots of the resource pool “A” including a slot in which SCI or PSCCH/PSSCH is received (the SL DRX inactivity timer is filled with only the sidelink slots of the resource pool “A” as much as a length of the SL DRX inactivity timer). The operation described above can also be equally applied to an operation based on an SL retransmission timer.

In another embodiment, the Rx UE performs the SL DRX operation using configured SL DRX configuration (SL DRX configuration configured by the Tx UE or SL DRX configuration configured per QoS profile). For example, the Rx UE applies an On Duration timer of the configured SL DRX configuration to perform an SL DRX active time operation. The Rx UE proposes to perform an active time (active mode) operation in SL slots of the sidelink resource pool “A” (a resource pool in which the SL DRX operation is supported, and which is selected to apply the configured SL DRX configuration) within a sidelink DRX OnDuration timer duration, and to exclude SL slots of the sidelink resource pool “B” (a resource pool in which the SL DRX operation is not supported) or the sidelink resource pool “C” (a resource pool in which the SL DRX operation is supported, but which is not selected by the Rx UE for the DRX operation) from counting of the SL DRX OnDuration timer.

The present disclosure proposes the SL DRX operation based on sidelink resource pool as follows.

In a sidelink DRX operation for conventional sidelink unicast communication. SL DRX configuration is applied per sidelink unicast (i.e., direction of a pair of source L2 ID and destination L2 ID). That is, one SL DRX configuration may be used per “direction of a pair of source L2 ID and destination L2 ID.” Further, in a sidelink DRX operation for conventional sidelink groupcast/unicast communication. SL DRX configuration is applied per sidelink groupcast/broadcast service (i.e., destination L2 ID). That is, one SL DRX configuration may be used per “destination L2 ID.”

It is proposed in the present disclosure that one SL DRX configuration used for the SL DRX operation operates per sidelink resource pool selected by the UE (Rx UE or Tx UE) (selected by the base station or the UE satisfies and selects specific criteria) in the sidelink unicast, groupcast, and broadcast.

For example, in Embodiment 1 below, if multiple sidelink resource pools (e.g., the sidelink resource pool “A” and the sidelink resource pool “B”) are configured to a UE on the time axis, one sidelink DRX configuration used in a specific sidelink unicast service or a specific sidelink groupcast/broadcast service may be limited and applied to one sidelink resource pool. For example, if a SL slot positioned at a start time of DRX Onduation timer duration of sidelink DRX configuration mapped to the specific sidelink unicast service or the specific sidelink groupcast/broadcast service is a slot of the sidelink resource pool “A”, the Rx UE proposes to include only slots belonging to the sidelink resource pool “A” in the sidelink DRX Onduration timer, and to exclude slots belonging to the sidelink resource pool “B” (a sidelink resource pool other than a resource pool (i.e., the sidelink resource pool “A”) including a slot in which SCI for the specific sidelink unicast/groupcast/broadcast service is received) from counting of the SL DRX Onduration timer. That is, the SL DRX Onduration timer is filled with only sidelink slots of the sidelink resource pool “A” as much as a length of the SL DRX Onduration timer.

Embodiment 1. Resource pool based Sidelink DRX Onduration timer operation method

Embodiment 2 below describes proposals and implementations for an operation of an SL DRX inactivity timer. In Embodiment 2 below, if multiple sidelink resource pools (e.g., the sidelink resource pool “A” and the sidelink resource pool “B”) are configured to a UE on the time axis, one sidelink DRX configuration used in a specific sidelink unicast service or a specific sidelink groupcast/broadcast service may be limited and applied to one sidelink resource pool. For example, for the specific sidelink unicast service or the specific sidelink groupcast/broadcast service, if the Rx UE receives SCI in a slot belonging to the sidelink resource pool “A” in an SL DRX Onduration timer duration of sidelink DRX configuration mapped to the corresponding service, the Rx UE includes only slots of the sidelink resource pool “A” in a sidelink DRX inactivity timer. That is, the Rx UE proposes to include only slots belonging to the sidelink resource pool “A” (resource pool including slots receiving the SCI) of a SL DRX inactivity timer duration being running in a sidelink DRX inactivity timer and not to include slots belonging to the sidelink resource pool “B” (a sidelink resource pool other than a resource pool (i.e., the sidelink resource pool “A”) including a slot in which SCI for the specific sidelink groupcast/broadcast service is received) of the SL DRX inactivity timer duration in the sidelink DRX inactivity timer. That is, the sidelink DRX inactivity timer includes only sidelink slots of the sidelink resource pool “A” including a slot in which SCI or PSCCH/PSSCH is received (the SL DRX inactivity timer is filled with only sidelink slots of the sidelink resource pool “A” as much as a length of the SL DRX inactivity timer).

Embodiment 2. Resource pool based Sidelink DRX inactivity timer operation method 1

Embodiment 3 below is another example of the Embodiment 2. In Embodiment 3, if a sidelink resource pool (the sidelink resource pool “B” in this embodiment) including slots, in which SCI is not received, is also included in a sidelink inactivity timer duration, slots of the sidelink resource pool “B” are also included in a sidelink DRX inactivity timer. When the Tx UE transmits a next new TB, the Tx UE can transmit the new TB by using a resource pool other than a resource pool used for transmitting a previous TB. Therefore, a duration in which an active time operation is performed within the SL DRX inactivity timer duration of the Rx UE can include slots of a resource pool (the sidelink resource pool “B” in this embodiment) in which the SCI is not received.

Embodiment 3. Resource pool based Sidelink DRX inactivity timer operation method 2

Embodiment 4 below describes proposals and implementations for an operation of an SL DRX retransmission timer. In Embodiment 4 below, if multiple sidelink resource pools (e.g., the sidelink resource pool “A” and the sidelink resource pool “B”) are configured to a UE on the time axis, one sidelink DRX configuration used in a specific sidelink unicast service or a specific sidelink groupcast/broadcast service may be limited and applied to one sidelink resource pool. For example, for the specific sidelink unicast service or the specific sidelink groupcast/broadcast service, if the Rx UE has received PSCCH/PSSCH in the sidelink resource pool “A” in Onduration timer duration of the corresponding service but fails to decode it, the Rx UE can start an SL DRX retransmission timer. In this instance, the Rx UE proposes to include only slots belonging to the sidelink resource pool “A” (resource pool including slots receiving the SCI) of a SL DRX retransmission timer duration being running in a sidelink DRX retransmission timer and not to include slots belonging to the sidelink resource pool “B” (a sidelink resource pool other than a resource pool (i.e., the sidelink resource pool “A”) including a slot in which SCI for the specific sidelink groupcast/broadcast service is received) of the SL DRX retransmission timer in the sidelink DRX retransmission timer. The general operation of the SL DRX retransmission timer is that a TB is retransmitted using the same resource pool as a sidelink resource pool used for actual transmission of the TB. Therefore, even if a resource pool including a slot in which PSCCH/PSSCH is not received is within the SL DRX retransmission timer duration, the Rx UE may not need to operate in an active time (active mode) in the resource pool. That is, the SL DRX retransmission timer includes only sidelink slots of the resource pool “A” including a slot in which the PSCCH/PSSCH is received (the SL DRX retransmission timer is filled with only the sidelink slots of the resource pool “A” as much as the length of the SL DRX inactivity timer).

Embodiment 4. Resource pool based Sidelink DRX Retransmission timer operation method

The present disclosure proposes the following SL DRX operation (Embodiments 5 to 7). In an operation for relay communication, a resource pool for a discovery message and a communication pool for an actual data message can be independently configured. Accordingly, the present disclosure proposes the following DRX operation in the relay communication.

For example, in Embodiment 5 below, if multiple sidelink resource pools (e.g., discovery resource pool “D” and communication resource pool “C”) are configured to a UE on the time axis, the following operation is proposed. For example, the UE performs an operation of monitoring a discovery message in the discovery resource pool “D” so as to receive the discovery message. When the UE performs an SL DRX operation for the monitoring of the discovery message, the UE proposes to include only slots included in the discovery resource pool “D” in Onduration timer duration and not to include slots included in the communication resource pool “C” in the Onduration timer duration. That is, because a UE monitoring a sidelink discovery message does not need to monitor a message for sidelink communication, even if the communication resource pool is within the duration of the Onduration timer, the UE may be configured not to monitor slots belonging to the communication resource pool.

Embodiment 5. Discovery Resource pool/Communication resource pool based Sidelink DRX Onduration timer operation method

Embodiment 6 below describes proposals and implementations for an operation of an SL DRX inactivity timer. In Embodiment 6 below, if multiple sidelink resource pools (e.g., discovery resource pool “D” and communication resource pool “C”) are configured to a UE on the time axis, the following operation is proposed. For example, if a UE monitoring a discovery message receives SCI in the discovery resource pool “D” of an Onduration timer duration, the UE can start an inactivity timer. In this instance, the UE proposes to include only slots included in the discovery resource pool “D” (resource pool including slots receiving the SCI) of the SL DRX inactivity timer duration being running in the SL DRX inactivity timer and not to include slots included in the communication resource pool “C” in the SL DRX inactivity timer. That is, the UE monitoring the discovery message does not need to monitor a message for communication. Therefore, when the UE receives the SCI in the Onduration timer duration and starts the inactivity timer, even if the communication resource pool is within the inactivity timer duration, the UE may be configured not to monitor slots belonging to the communication resource pool.

Embodiment 6. Discovery Resource pool/Communication resource pool based Sidelink DRX inactivity timer operation method

Embodiment 7 below describes proposals and implementations for an operation of an SL DRX retransmission timer. In Embodiment 7 below, if multiple sidelink resource pools (e.g., discovery resource pool “D” and communication resource pool “C”) are configured to a UE on the time axis, the following operation is proposed. For example, if the UE has received PSCCH/PSSCH in slots of the discovery resource pool “D” in an Onduration timer duration so as to monitor a discovery message but fails to decode it, the UE can start the SL DRX retransmission timer. In this instance, the UE proposes to include only slots included in the discovery resource pool “D” (resource pool including slots receiving the SCI) of the SL DRX retransmission timer duration being running in the SL DRX retransmission timer and not to include slots included in the communication resource pool “C” in the SL DRX retransmission timer. The general operation of the SL DRX retransmission timer is that a TB is retransmitted using the same resource pool as a sidelink resource pool used for actual transmission of the TB. Therefore, even if a resource pool including a slot in which PSCCH/PSSCH is not received is within the SL DRX retransmission timer duration, the UE may not need to operate in an active time (active mode) in the resource pool.

Embodiment 7. Discovery Resource pool/Communication resource pool based Sidelink DRX Retransmission timer operation method

The operation of the present disclosure can be applied to all the sidelink unicast/groupcast/broadcast operations.

The operation of the present disclosure can operate per Direction of a pair of Source L2 ID and Destination L2 ID in the sidelink unicast. The operation of the present disclosure can also operate per L2 Destination ID in sidelink groupcast/broadcast.

The sidelink DRX configuration mentioned in the present disclosure may include at least one of the following parameters.
Sidelink DRX configurations
✓ SL drx-onDurationTimer: the duration at the beginning of a SL DRX Cycle;
✓ SL drx-SlotOffset: the delay before starting the sl drx-onDurationTimer;
✓ SL drx-InactivityTimer: the duration after the PSCCH occasion in which a PSCCH indicates a new SL transmission for the MAC entity;
✓ SL drx-StartOffset: the subframe where the SL DRX cycle start;
✓ SL drx-Cycle: the SL DRX cycle;
✓ SL drx-HARQ-RTT-Timer (per HARQ process or per sidelink process): the minimum duration before an assignment for HARQ retransmission is expected by the MAC entity.
✓ SL drx-RetransmissionTimer (per HARQ process or per sidelink process): the maximum duration until a retransmission is received

A sidelink DRX timer below mentioned in the present disclosure can be used for the following purposes.
Sidelink DRX Onduration Timer
   A time duration, in which a UE performing a sidelink DRX operation shall basically operate in active time to receive PSCCH/PSSCH of other UE, is defined.
Sidelink DRX Inactivity Timer
   Sidelink DRX Onduration period, which is a time duration in which the UE performing the sidelink DRX operation shall basically operate in active time to receive the PSCCH/PSSCH of the other UE, is extended. That is, the Sidelink DRX Onduration period can be extended as much as Sidelink DRX Inactivity Timer duration. In addition, if the UE receives a new packet (new PSSCH transmission) from the other UE, the UE can start the Sidelink DRX Inactivity Timer and extend the Sidelink DRX Onduration timer period.
Sidelink DRX HARQ RTT Timer
   A time duration, in which the UE performing the sidelink DRX operation operates in a sleep mode until receiving a retransmission packet (or PSSCH assignment) transmitted by the other UE, is defined. That is, if the UE starts Sidelink DRX HARQ RTT Timer, the UE determines that the other UE will not transmit a sidelink retransmission packet to itself until the Sidelink DRX HARQ RTT Timer expires, and operates in the sleep mode during the corresponding timer.
Sidelink DRX Retransmission Timer
   A time duration in which the UE performing the sidelink DRX operation operates in active time to receive the retransmission packet (or PSSCH assignment) transmitted by the other UE is defined. During the corresponding timer time duration, the UE monitors reception of a retransmission sidelink packet (or PSSCH assignment) transmitted by the other UE.

An Uu DRX timer below mentioned in the present disclosure can be used for the following purposes.
drx-HARQ-RTT-TimerSL Timer
   A time duration, in which a Tx UE (UE supporting Uu DRX operation) performing sidelink communication based on sidelink resource allocation mode 1 does not monitor PDCCH (or DCI) for sidelink mode 1 resource allocation transmitted by a base station, is defined.
drx-RetransmissionTimerSL Timer
   A time duration, in which the Tx UE (UE supporting the Uu DRX operation) performing the sidelink communication based on the sidelink resource allocation mode 1 monitors PDCCH (or DCI) for the sidelink mode 1 resource allocation transmitted by the base station, is defined.

In the following description, the names of the timers (Sidelink DRX Onduration Timer, Sidelink DRX Inactivity Timer, Sidelink DRX HARQ RTT Timer, Sidelink DRX Retransmission Timer, etc.) are merely an example, and timers performing the same/similar functions based on the content described for each timer may be considered as the same/similar timers regardless of their names.

The proposals of the present disclosure can be applied and extended as a method of solving a problem of loss due to interruption occurring during Uu bandwidth part (BWP) switching.

The proposals of the present disclosure can also be applied and extended as a method of solving a problem of loss due to interruption occurring during sidelink bandwidth part (BWP) switching when the UE supports sidelink multiple bandwidth part (BWP).

The proposals of the present disclosure can be extended and applied to not only parameters (and timers) included in default/common Sidelink DRX configuration or default/common Sidelink DRX pattern or default/common Sidelink DRX configuration, but also parameters (and timers) included in UE-pair specific Sidelink DRX configuration or UE-pair specific Sidelink DRX pattern or UE-pair specific Sidelink DRX configuration. The term “Onduration” mentioned in the proposals of the present disclosure can be interpreted/applied as a duration of the active time (a time duration in which it operates in a wake up state (RF module is “On”) to receive/transmit a radio signal). The term “Offduration” may be extended and interpreted as a time duration of sleep time (it means a time duration in which it operates in a sleep mode state (RF module is “Off”) for power saving. And, it does not mean that the transmitting UE shall compulsorily operate in the sleep mode in the sleep time duration. If necessary, even in the sleep time, the UE is allowed to operate in the active time for a while for sensing operation/transmission operation). In addition, “whether to apply (some) proposal methods/rules of the present disclosure and/or related parameters (e.g., threshold) may be configured characteristically (or differently or independently) based on resource pool, congestion level, service priority (and/or type). QOS requirements (e.g., latency, reliability) or PQI, traffic type (e.g., (a) periodic generation), sidelink transmission resource allocation mode (mode 1, mode 2), etc.”

For example, whether to apply the proposal rules of the present disclosure (and/or setting values of related parameters) may be configured characteristically (and/or differently and/or independently) for at least one of a resource pool, service/packet type (and/or priority). QoS requirements (e.g., URLLC/EMBB traffic, reliability, latency), PQI, PFI, cast type (e.g, unicast, groupcast, broadcast). (resource pool) congestion level (e.g., CBR). SL HARQ feedback scheme (e.g., NACK Only Feedback. ACK/NACK Feedback), transmission of HARQ Feedback Enabled MAC PDU (and/or HARQ Feedback Disabled MAC PDU), whether to configure PUCCH based SL HARQ feedback reporting operation, in the case of performing pre-emption (and/or Re-Evaluation) (or reselection of resources). (L2 or L1) (Source and/or Destination) identifier. (L2 or L1) (combination of source layer ID and destination layer ID) identifier. (L2 or L1) (combination of a pair of Source layer ID and Destination layer ID and Cast type) identifier, direction of a pair of Source layer ID and Destination layer ID. PC5 RRC Connection/Link, in case of performing SL DRX. SL mode type (resource allocation mode 1, resource allocation mode 2), in case of (a) periodic resource reservation.

The “certain time duration” mentioned in the proposals of the present disclosure refers to time operating as Active Time as much as predefined time for the UE to receive sidelink signals or sidelink data from the other UE, or time operating as Active Time as much as the time of a specific timer (Sidelink DRX Retransmission Timer or Sidelink DRX Inactivity Timer or a timer that guarantees that the DRX operation of the Rx UE can operate in Active Time).

Whether to apply the proposals and proposal rules of the present disclosure (and/or setting values of related parameters) can also be applied to mmWave Sidelink operation.

Various embodiments of the present disclosure can be combined with each other.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

FIG. W1 shows a communication system 1 based on an embodiment of the present disclosure. The embodiment of FIG. W1 may be combined with various embodiments of the present disclosure.

Referring to FIG. W1, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

Here, wireless communication technology implemented in wireless devices (100a˜100f) of the present disclosure may include Narrow band Internet of Things for low-power communication in addition to LTE. NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices (100a˜100f) of the present disclosure may perform communication based on LTE-M technology. In this case, as an example, the LTE-M technology may be an example of the LPWAN and may be called various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M. Additionally or alternatively, the wireless communication technology implemented in the wireless devices (100a˜100f) of the present disclosure may includes at least one of ZigBee, Bluetooth, and Low Power Wide Area Network (LPWAN) considering the low-power communication, and is not limited to the name described above. As an example, the ZigBee technology may generate personal area networks (PAN) associated with small/low-power digital communication based on various standards including IEEE 802.15.4, and the like, and may be called various names.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a. 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

FIG. X1 shows wireless devices based on an embodiment of the present disclosure. The embodiment of FIG. X1 may be combined with various embodiments of the present disclosure.

Referring to FIG. X1, a first wireless device 100 and a second wireless device 200 may transmit radio signals through a variety of RATs (e.g., LTE and NR). Herein. {the first wireless device 100 and the second wireless device 200} may correspond to {the wireless device 100x and the BS 200} and/or {the wireless device 100x and the wireless device 100x} of FIG. W1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC. RLC. PDCP. RRC, and SDAP). The one or more processors 102 and 202 may generate one or more Protocol Data Units (PDUs) and/or one or more Service Data Unit (SDUs) based on the descriptions, functions, procedures, proposals, methods, and/or operational flowcharts disclosed in this document. The one or more processors 102 and 202 may generate messages, control information, data, or information based on the descriptions, functions, procedures, proposals, methods, and/or operational flowcharts disclosed in this document. The one or more processors 102 and 202 may generate signals (e.g., baseband signals) including PDUs, SDUs, messages, control information, data, or information based on the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs. SDUs, messages, control information, data, or information based on the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs). Random Access Memories (RAMs). Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels. etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. X2 shows a signal process circuit for a transmission signal based on an embodiment of the present disclosure. The embodiment of FIG. X2 may be combined with various embodiments of the present disclosure.

Referring to FIG. X2, a signal processing circuit 1000 may include scramblers 1010, modulators 1020, a layer mapper 1030, a precoder 1040, resource mappers 1050, and signal generators 1060. An operation/function of FIG. X2 may be performed, without being limited to, the processors 102 and 202 and/or the transceivers 106 and 206 of FIG. X1. Hardware elements of FIG. X2 may be implemented by the processors 102 and 202 and/or the transceivers 106 and 206 of FIG. X1. For example, blocks 1010 to 1060 may be implemented by the processors 102 and 202 of FIG. X1. Alternatively, the blocks 1010 to 1050 may be implemented by the processors 102 and 202 of FIG. X1 and the block 1060 may be implemented by the transceivers 106 and 206 of FIG. X1.

Codewords may be converted into radio signals via the signal processing circuit 1000 of FIG. X2. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein. N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules. Cyclic Prefix (CP) inserters. Digital-to-Analog Converters (DACs), and frequency up-converters.

Signal processing procedures for a signal received in the wireless device may be configured in a reverse manner of the signal processing procedures 1010 to 1060 of FIG. X2. For example, the wireless devices (e.g., 100 and 200 of FIG. X1) may receive radio signals from the exterior through the antenna ports/transceivers. The received radio signals may be converted into baseband signals through signal restorers. To this end, the signal restorers may include frequency downlink converters. Analog-to-Digital Converters (ADCs). CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

FIG. X3 shows another example of a wireless device based on an embodiment of the present disclosure. The wireless device may be implemented in various forms based on a use-case/service (refer to FIG. W1). The embodiment of FIG. X3 may be combined with various embodiments of the present disclosure.

Referring to FIG. X3, wireless devices 100 and 200 may correspond to the wireless devices 100 and 200 of FIG. X1 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. X1. For example, the transceiver(s) 114 may include the one or more transceivers 106 and 206 and/or the one or more antennas 108 and 208 of FIG. X1. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured based on types of wireless devices. For example, the additional components 140 may include at least one of a power unit/battery, input/output (I/O) unit, a driving unit, and a computing unit. The wireless device may be implemented in the form of, without being limited to, the robot (100a of FIG. W1), the vehicles (100b-1 and 100b-2 of FIG. W1), the XR device (100c of FIG. W1), the hand-held device (100d of FIG. W1), the home appliance (100e of FIG. W1), the IoT device (100f of FIG. W1), a digital broadcast terminal, a hologram device, a public safety device, an MTC device, a medicine device, a fintech device (or a finance device), a security device, a climate/environment device, the AI server/device (400 of FIG. W1), the BSs (200 of FIG. W1), a network node, etc. The wireless device may be used in a mobile or fixed place based on a use-example/service.

In FIG. X3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. X3 will be described in detail with reference to the drawings.

FIG. X4 shows a hand-held device based on an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT). The embodiment of FIG. X4 may be combined with various embodiments of the present disclosure.

Referring to FIG. X4, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. X3, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

FIG. X5 shows a vehicle or an autonomous vehicle based on an embodiment of the present disclosure. The vehicle or autonomous vehicle may be implemented by a mobile robot, a car, a train, a manned/unmanned Aerial Vehicle (AV), a ship, etc. The embodiment of FIG. X5 may be combined with various embodiments of the present disclosure.

Referring to FIG. X5, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. X3, respectively.

The communication unit 110 may transmit and receive signals (e.g., data and control signals) to and from external devices such as other vehicles. BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path based on the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

1. A method performed by a second user equipment (UE) supporting a sidelink discontinuous reception (SL DRX) in a wireless communication system, the method comprising:
receiving, from a base station, configuration information related to a resource pool for a sidelink communication;
receiving, from a first UE, sidelink control information (SCI); and
receiving, from the first UE, data based on the SCI,
wherein the SCI is received through a monitoring performed in an active time based on a configuration related to the SL DRX,
wherein the active time includes a time duration in which a pre-configured SL DRX timer is running,
wherein a length of the time duration in which the pre-configured SL DRX timer is running based on the configuration related to the SL DRX is set to a predefined value,
wherein the time duration in which the pre-configured SL DRX timer is running includes one or more slots based on the predefined value, and
wherein a slot of a resource pool other than a predefined resource pool among slots determined by physical slot indexes related to the predefined value is excluded from the one or more slots.

2. The method of claim 1, wherein the configuration information includes information for at least one of i) a resource pool in which the SL DRX is supported and/or ii) a resource pool in which the SL DRX is not supported, and
wherein the resource pool in which the SL DRX is supported includes i) a first resource pool related to a sidelink discovery and ii) a second resource pool related to the sidelink communication.

3. The method of claim 2, wherein the predefined resource pool is based on the resource pool in which the SL DRX is supported, and
wherein the resource pool other than the predefined resource pool is based on the resource pool in which the SL DRX is not supported.

4. The method of claim 2, wherein the predefined resource pool is based on the first resource pool or the second resource pool, and
wherein the resource pool other than the predefined resource pool is based on the second resource pool or the first resource pool.

5. The method of claim 4, wherein based on the second UE being a remote UE performing the sidelink discovery, the predefined resource pool is the first resource pool.

6. The method of claim 4, wherein based on the second UE being an Rx UE performing the sidelink communication, the predefined resource pool is the second resource pool.

7. The method of claim 1, wherein the pre-configured SL DRX timer includes at least one of i) an SL DRX Onduration timer, ii) an SL DRX inactivity timer, and/or iii) an SL DRX retransmission timer.

8. The method of claim 7, wherein based on the pre-configured SL DRX timer being the SL DRX Onduration timer or the SL DRX retransmission timer, the one or more slots include only a slot of the predefined resource pool.

9. The method of claim 7, wherein based on the pre-configured SL DRX timer being the SL DRX inactivity timer, the one or more slots include i) a slot of the predefined resource pool and ii) a slot of the resource pool other than the predefined resource pool.

10. The method of claim 1, wherein a slot related to a Uu link among the slots determined by the physical slot indexes related to the predefined value is excluded from the one or more slots.

11. A second user equipment (UE) supporting a sidelink discontinuous reception (SL DRX) in a wireless communication system, the second UE comprising:
one or more transceivers;
one or more processors configured to control the one or more transceivers; and
one or more memories operably connected to the one or more processors,
wherein the one or more memories are configured to store instructions performing operations based on being executed by the one or more processors,
wherein the operations comprise:
receiving, from a base station, configuration information related to a resource pool for a sidelink communication;
receiving, from a first UE, sidelink control information (SCI); and
receiving, from the first UE, data based on the SCI,
wherein the SCI is received through a monitoring performed in an active time based on a configuration related to the SL DRX,
wherein the active time includes a time duration in which a pre-configured SL DRX timer is running,
wherein a length of the time duration in which the pre-configured SL DRX timer is running based on the configuration related to the SL DRX is set to a predefined value,
wherein the time duration in which the pre-configured SL DRX timer is running includes one or more slots based on the predefined value, and
wherein a slot of a resource pool other than a predefined resource pool among slots determined by physical slot indexes related to the predefined value is excluded from the one or more slots.

12-14. (canceled)

15. A first user equipment (UE) for transmitting data in a wireless communication system, the first UE comprising:
one or more transceivers;
one or more processors configured to control the one or more transceivers; and
one or more memories operably connected to the one or more processors,
wherein the one or more memories are configured to store instructions performing operations based on being executed by the one or more processors,
wherein the operations comprise:
receiving, from a base station, configuration information related to a resource pool for a sidelink communication;
transmitting, to a second UE, sidelink control information (SCI); and
transmitting, to the second UE, the data based on the SCI,
wherein the SCI is transmitted in an active time in which a monitoring of the second UE is performed based on a configuration related to a sidelink discontinuous reception (SL DRX),
wherein the active time includes a time duration in which a pre-configured SL DRX timer is running,
wherein a length of the time duration in which the pre-configured SL DRX timer is running based on the configuration related to the SL DRX is set to a predefined value,
wherein the time duration in which the pre-configured SL DRX timer is running includes one or more slots based on the predefined value, and
wherein a slot of a resource pool other than a predefined resource pool among slots determined by physical slot indexes related to the predefined value is excluded from the one or more slots.
